(19) United States
(12) Patent Application Publication
(10) Pub. No.: US 2025/0162413 A1
(43) Pub. Date: May 22, 2025

(54) SYSTEMS AND METHODS FOR GESTURE INPUT ON A STEERING WHEEL

(71) Applicant: Adeia Guides Inc., San Jose, CA (US)

(72) Inventors: Dhananjay Lal, Englewood, CO (US); Zhiyun Li, Kenmore, WA (US); Charles Dasher, Lawrenceville, GA (US); Christopher Phillips, Hartwell, GA (US); Tao Chen, Palo Alto, CA (US); Reda Harb, Tampa, FL (US)

(21) Appl. No.: 18/511,104

(22) Filed: Nov. 16, 2023

(51) Int. Cl. B60K 35/10; B62D 1/04; G06F 3/041; G06N 3/044

(52) U.S. Cl. CPC B60K 35/10; B62D 1/046; G06F 3/04144; G06N 3/044; B60K 2360/143; B60K 2360/1468; B60K 2360/782; G06F 2203/04105

(57) ABSTRACT

Sensors disposed on a steering wheel sense contact of a user's hands with the steering wheel. The sensors are arranged into several zones that wrap around the steering wheel. Each zone is adjacent to at least two other zones. Data from the sensors is continuously received by input/output circuitry. Control circuitry determines a time series of pressures for each zone based on the data from the sensors. The time series of pressures for the zones are stored in a data structure that is looped. The time series of pressures of the data structure is compared to a time series of pressures of a reference data structure. An action to control at least one element of the vehicle is performed based on the comparison. In some embodiments, the steering wheel includes handlebars and the sensors are disposed in handlebar grips.

### BACKGROUND

This disclosure is directed to systems and methods for controlling systems of a vehicle.

### SUMMARY

Car instrument panels and dashboards have a host of controls that assist in driving or in other functions that may need to be performed by a driver. The other functions may include interfacing with entertainment controls (e.g., for radio or other media), environment controls (e.g., for heating and cooling, defroster, or windshield wipers), lighting controls (e.g., for turn signals, headlights, fog lights, driving lights, or interior lights), driving controls (e.g., for overdrive, traction control, cruise control, four-wheel drive, or different driving modes such as fuel efficient and sport), navigation controls (e.g., for entering a destination, selecting trip routes, or manipulating a map), communication controls (e.g., for engaging in phone calls or text messaging and blowing a horn), vehicle information (e.g., for oil level, vehicle alerts, or maintenance records), or gear controls (e.g., for park, reverse, or low gearing), to name a few examples. Levers, dials, and knobs used to interface with these controls may require the driver to loosen or remove their grip from the steering wheel, which may be inconvenient if not dangerous. Thus, systems and methods for intuitively interfacing with vehicle controls that accommodate different hand positions on the steering wheel and do not require a driver to loosen or remove their grip from the steering wheel are needed.

In one approach, controls may be moved near or on the steering wheel. For example, a blinker control lever may be positioned behind the steering wheel and a horn control button may be located on the center hub of the steering wheel. For motorcycles, the controls are positioned near the left and right grips of the handlebars (e.g., steering wheel) because the hands of the user riding the motorcycle must be on the handlebars to operate the motorcycle. Thumb-actuated controls include turn signals, horn, high/low beam, on-off switch, and engine start switch. Lever controls include the front brake and clutch levers. The right grip may be twistable to open and close the throttle. However, systems such as entertainment, infotainment, or navigation systems may have controls located away from the handlebars, such as knobs, buttons, or a touch screen, that require the user to remove their grip of the handlebars.

While placing the controls on or near the steering wheel allows for easier access to the controls, it requires a driver to remove or loosen their grip from the steering wheel to access the controls. The driver may need to focus their gaze on the buttons to identify the functions corresponding to the buttons, diverting their attention from driving. Controls, such as volume controls for the entertainment or infotainment system, may be located on the spokes of the steering wheel. While this does not require the driver to remove their grip, it does not allow the driver to grip areas of the steering wheel that are not within reach of the controls. Since the buttons are part of or near the steering wheel, the user must mentally track the location of the buttons, as the steering wheel moves which can distract from driving. Further, since the user may grip the steering wheel above or below the spokes, the user may need to loosen their grip to reach the controls located on the spoke. Placing the controls too close to the steering wheel or the user's hands may result in inadvertent activation of the controls.

In another approach, a voice activation system may be used to interface with the vehicle controls. Specific phrases may be uttered to place a phone call, send a text message, or play a song. For example, a user may utter “Hey Google, play Van Halen's 1984 album” or “Hey Siri, call Nardozzo's pizzeria.” While this approach allows the user to keep their hands on the wheel while interfacing with the controls, it is not without limitations. Voice activation systems may use predetermined phrases to initiate an action and it may be difficult to learn or remember several phrases. Noise from the surroundings, such as music playing or road noise, may make it difficult for the voice activation system to hear the driver speak. Utterances from people other than the driver may inadvertently initiate an action. The time needed to utter and recognize the specific phrase may be longer than the response time needed to perform the action, such as activating a blinker. A user may not want to be constantly monitored by such a system. Further, voice activation systems are not always responsive and may frustrate the user, reducing their ability to focus on driving. Thus, a voice activation system may not provide an intuitive and effective means of hands-free control.

Accordingly, there is a need to provide drivers with intuitive control of vehicle systems without loosening their grip on the steering wheel or requiring the driver to grip a predetermined portion of the steering wheel. Such a solution leverages sensors integrated into the steering wheel to determine gestures made on the steering wheel to control vehicle systems.

To solve these problems, systems and methods are provided herein for using contact of a user's hands with a steering wheel to perform an action to control elements of a vehicle.

In one approach, sensors disposed on a steering wheel sense contact of a user's hands with the steering wheel. The sensors are arranged into several zones that wrap around the steering wheel. Each zone is adjacent to at least two other zones. The “wrapped” zones allow the user to contact or grip the steering wheel at any position on the steering wheel and perform a gesture input without loosening their grip or having to grip a predetermined portion of the steering wheel.

Data from the sensors is continuously received by input/output (I/O) circuitry. Control circuitry determines pressures over time (e.g., a time series of pressures) for each zone based on data received from sensors in each zone. The time series of pressures for the zones are stored in a data structure and each time series of pressures is adjacent to two other time series of pressures. For example, each zone may be assigned a number in the data structure and the lowest and highest numbered zones may be adjacent to one another on the steering wheel. The data structure is looped such that the time series of pressures for the lowest and highest numbered zones may be considered together in a subset of the time series of pressures.

The time series of pressures of data structure that is looped is compared to a time series of pressures of a reference data structure. An action to control at least one element of the vehicle is performed based on the comparison. For example, a subset of the time series of pressures in the data structure that is looped may contain a sequence of pressures varying over time for at least one zone. The sequence may be compared to the time series of pressures in the reference data structure to determine if there is a match, and if so, a corresponding action is performed. The comparison may be performed using mathematical computations or a trained machine learning model.

In another approach, finger mapping is used to track each of the user's fingers and determine a gesture input. Data received from the plurality of sensors is used to identify each finger in contact with the steering wheel. As the fingers move in relation to the steering wheel, gesture inputs are determined. The gesture inputs are compared to a datastore, database, or data structure to identify or associate an action to control a vehicle element, and if a match is found the action is performed. Using finger mapping may allow the user to intuitively interface with vehicle controls by performing an input gesture at any position on the steering wheel without loosening their grip or having to interface with a predetermined portion of the steering wheel.

In another approach, at least one of the reference data structure, association of the reference data structure with the action to control the vehicle elements, or association of particular gestures with the action to control the vehicle elements are stored in a profile of the user. The user profile may be stored with a manufacturer of the vehicle or a provider of service layer applications, such as Google, Apple, or Amazon. Information for the user profile can be recalled for use in any vehicle that the user operates. For example, a user in a rental vehicle may recall associations of particular gestures with actions to control vehicle elements of the rental vehicle from a local device or the cloud so the user does not have to re-train or re-calibrate the rental vehicle. The new or temporary vehicle on which this is applied may support a “standard” on recognition of grip gestures (e.g., time sequences of pressure or capacitive touch). To implement such a standard, a vehicle original equipment manufacturer (OEM) may be required to have a minimum density of sensors on the steering wheel to allow measurement of precise sensor output values on the steering wheel in space and time. Other settings associated with the user profile may also be recorded to associate with the user profile, such as seat configuration and mirror configuration, to name a few examples. Storing the associations of the particular gestures with the actions in the user profile with the other settings allows a user to apply their preferences to different vehicles or temporary vehicles.

In another approach, sensors are disposed on grips of handlebars, such as of a motorcycle. The sensors allow the user to interact with the grips to control elements of the motorcycle. For example, the user may perform a gesture input on the grips to intuitively control a motorcycle element while safely maintaining their grip on the handlebars. Thus, the user does not need to remove or loosen their grip to control the motorcycle elements, which allows the user to maintain their grip and may increase rider safety. The sensors may also accommodate different hand positions on the grips.

Using the methods described herein, a user may intuitively interface with vehicle controls in a way that accommodates different hand positions on a steering wheel of the vehicle, and does not require a user to loosen or remove their grip from the steering wheel.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1A and 1B are schematic illustrations of a process of training and using a system for receiving input on a steering wheel of a vehicle to control elements of the vehicle, in accordance with embodiments of the disclosure;

FIG. 2 is a schematic illustration of a process of training a system for receiving input on a steering wheel of a vehicle to control elements of the vehicle, in accordance with embodiments of the disclosure;

FIG. 3A shows a schematic illustration of training a machine learning model to associate a time series of pressures with an action to control an element of a vehicle, in accordance with embodiments of the disclosure;

FIG. 3B shows a schematic illustration of using a trained machine learning model to compare a time series of pressures of a data structure that is looped to a time series of pressures of a training data structure, in accordance with embodiments of the disclosure;

FIG. 4A shows an illustration of a gesture input to a steering wheel having a plurality of zones, in accordance with embodiments of the disclosure;

FIG. 4B shows a side sectional illustration of the steering wheel of FIG. 4A, in accordance with embodiments of the disclosure;

FIG. 4C shows a plot of a time series of pressures for each zone of the steering wheel corresponding to the gesture of FIG. 4A, in accordance with embodiments of the disclosure;

FIG. 5A is a schematic illustration of a process of mapping a user profile trained on a first steering wheel to data from sensors of a second steering wheel, in accordance with embodiments of the disclosure;

FIG. 5B shows a schematic illustration of mapping a user profile containing an ML model trained on a first steering wheel to a second steering wheel, in accordance with embodiments of the disclosure;

FIG. 6 shows an illustration of a heads-up display for presenting gesture inputs to a user, in accordance with embodiments of the disclosure;

FIG. 7 is a schematic illustration of a process for presenting a liquid tactile button for receiving an input to a steering wheel, in accordance with embodiments of the disclosure;

FIG. 8 shows an illustration of a lights in a steering wheel to present a gesture input sequence to a user, in accordance with embodiments of the disclosure;

FIG. 9 shows a schematic illustration of determining a health condition based on inputs to a steering wheel, in accordance with embodiments of the disclosure;

FIG. 10A shows an illustration of handlebars having a plurality of zones for receiving a gesture input, in accordance with embodiments of the disclosure;

FIG. 10B shows a side sectional illustration of the handlebars of FIG. 10A, in accordance with embodiments of the disclosure;

FIG. 11 is a schematic illustration of a process of tracking finger movements on a steering wheel of a vehicle to control elements of the vehicle, in accordance with embodiments of the disclosure;

FIG. 12 depicts example devices and related hardware for receiving input on a steering wheel of a vehicle and performing an action to control at least one element of the vehicle based on the input, in accordance with some embodiments of this disclosure; and

FIG. 13 depicts example systems, servers, and related hardware for enabling a vehicle element control application to carry out the functions described herein, in accordance with some embodiments of this disclosure.

### DETAILED DESCRIPTION

As referred to herein, the phrase “steering wheel” refers to any kind of component that a user can physically manipulate to control a direction of a vehicle. For example, the user may grasp or grip the steering wheel and move it to change a direction of travel of the vehicle. That is, the user may rotate the steering wheel clockwise or counterclockwise to turn right and left, respectively. In some embodiments, the steering wheel may not be a “wheel.”

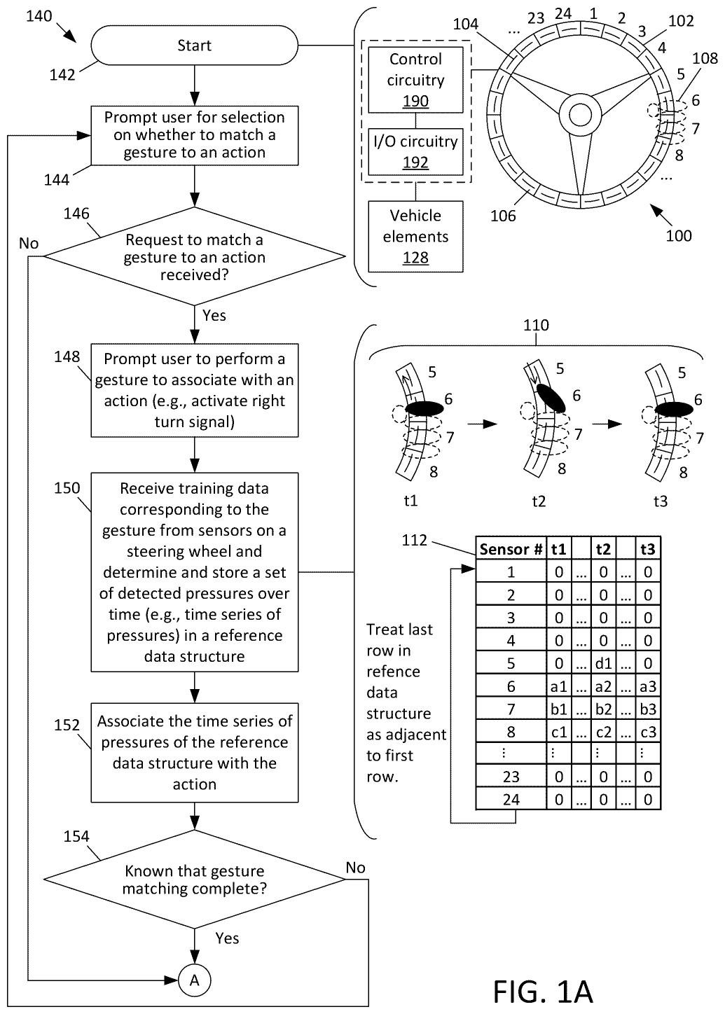

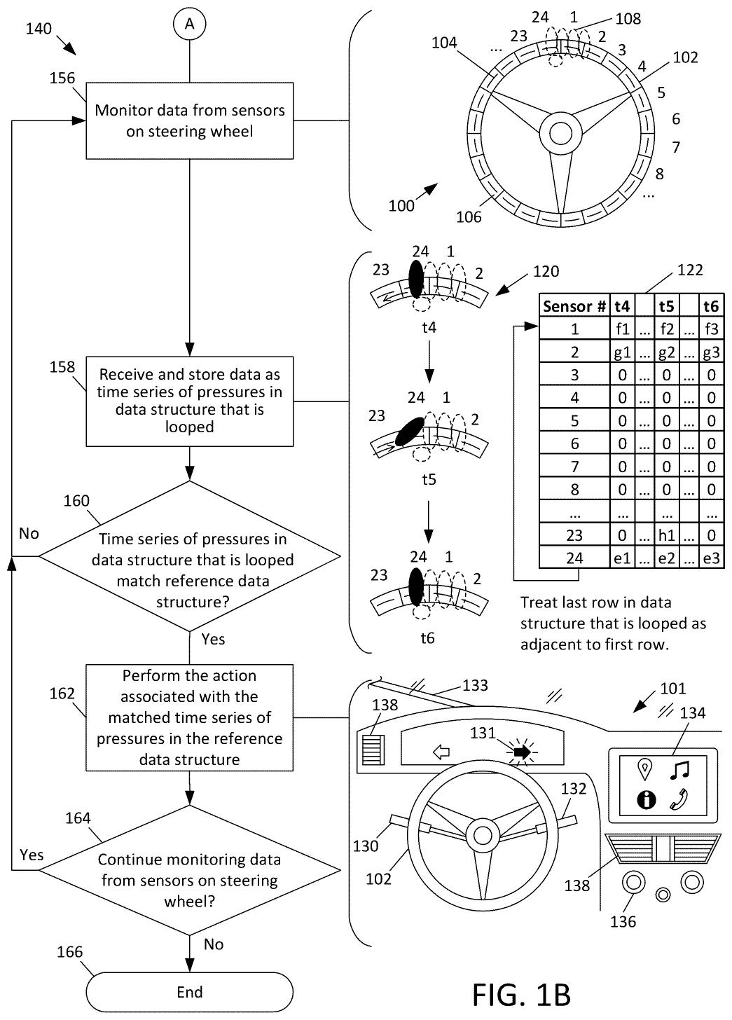

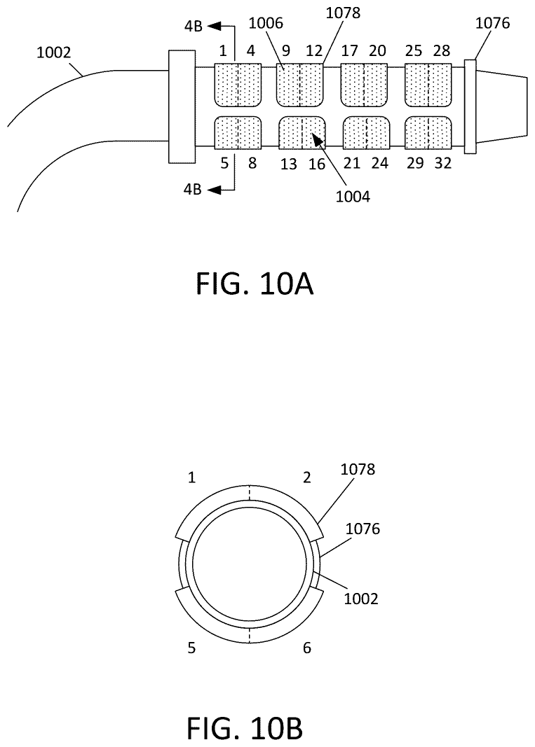

As referred to herein, the phrase “rim” refers to any kind of grip portion of a steering wheel. For example, a user may grasp or grip the rim to turn the steering wheel. That is, the rim is the potion of the steering wheel the user interfaces with to steer the vehicle. In some embodiments, the rim is the outermost part of the steering wheel. In some embodiments, the rim may have a circular shape, such as later discussed in relation to FIGS. 1A and 1B. In some embodiments, the rim may have a non-circular shape, such as an oval, ellipse, rectangular-shape, or a circle-like shape with a flat section as its bottom. In some embodiments, the rim may not form a closed shape. For example, the rim may have a circular shape with a gap at the top, such as between an 11 o'clock and 1 o'clock position. In some embodiments, the rim may be any shape that allows the user to grip and manipulate the steering wheel to control the vehicle. For example, the steering wheel may be handlebars and the rim may be a grip section of the handlebars, such as later discussed in relation to FIGS. 10A and 10B.

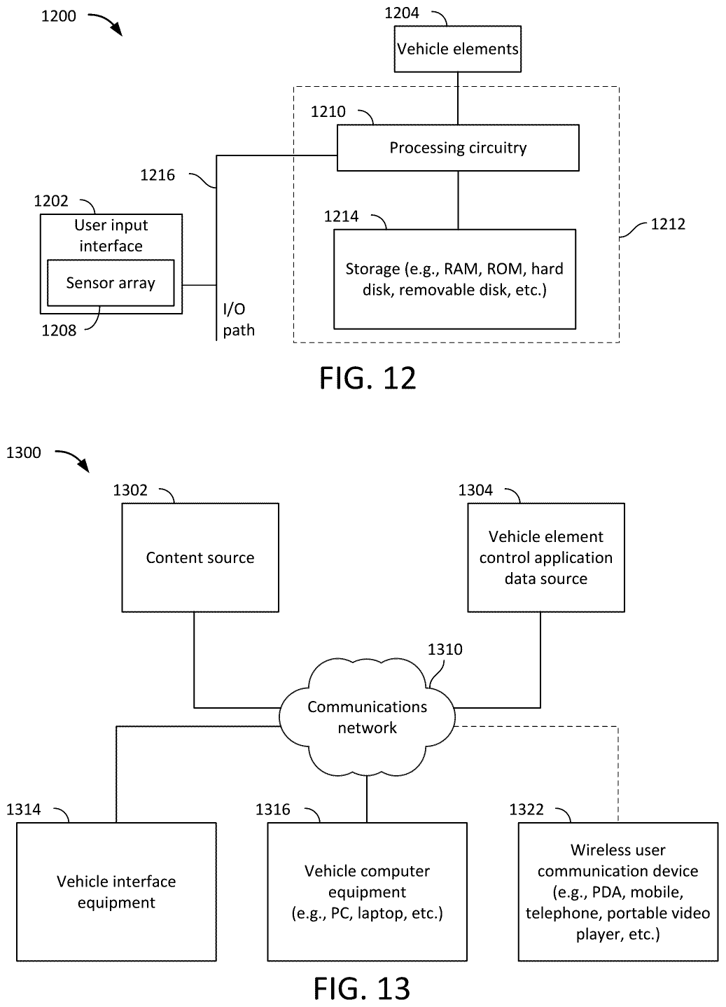

FIGS. 1A and 1B are schematic illustrations of a process 140 of training and using a system 100 for receiving input on a steering wheel 102 of a vehicle 101 to control elements 128 of the vehicle 101, in accordance with embodiments of the disclosure. In particular, FIG. 1A shows initialization of the system 100 and training to associate a gesture input 110 to a steering wheel 102 (e.g., user input interface 1202 and vehicle interface equipment 1314, discussed below in relation to FIGS. 12 and 13) with an action to control at least one element 128 of the vehicle 101 (the vehicle 101 is depicted in FIG. 1B). FIG. 1B shows monitoring inputs to the steering wheel 102 and using the inputs to control the functions of the vehicle 101. The system 100 may be used to reduce driver distractions associated with conventional systems for interfacing with vehicle controls. For example, the system 100 may be used in combination with the methods below to substantially increase the time the user grips the steering wheel 102 and remains attentive to the vehicle's surroundings.

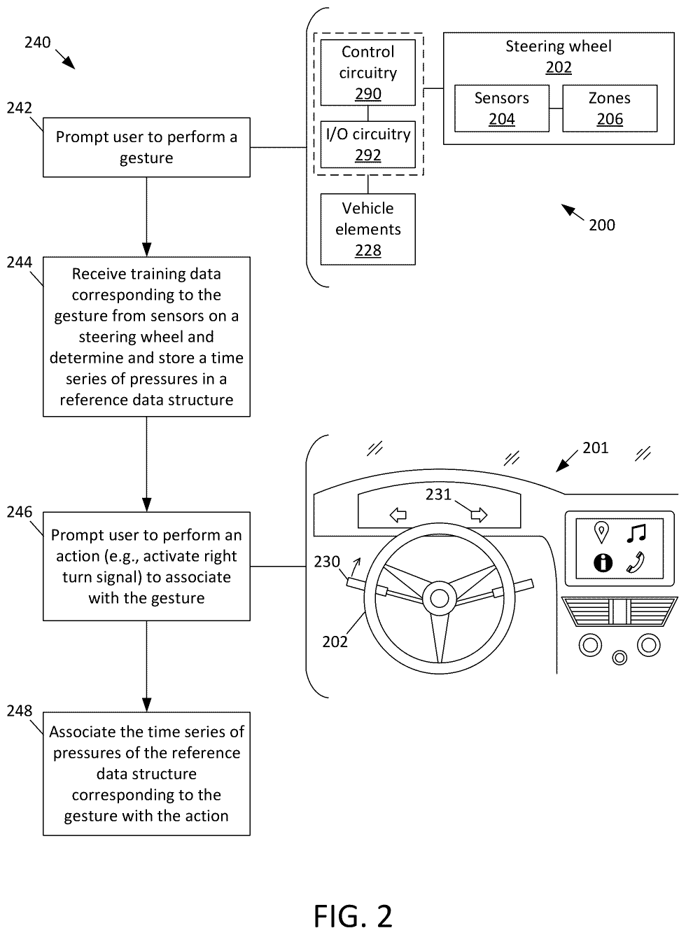

Referring to FIG. 1A, the process 140 starts at operation 142 with control circuitry 190 (or, e.g., control circuitry 290, 1212 discussed below in relation to FIGS. 2 and 12) initializing the system 100. The control circuitry 190 may execute the system 100, which includes a steering wheel 102, the control circuitry 190, and input/output (I/O) circuitry 192. The I/O circuitry 192 receives input from the steering wheel 102. A data source (e.g., vehicle element control application data source 1304, discussed below in relation to FIG. 13) may provide the input data from the steering wheel 102 to the control circuitry 190. The control circuitry 190 processes the input and sends a command to perform an action to control vehicle elements 128 (e.g., vehicle elements 1204, discussed below in relation to FIG. 12). The control circuitry 190 may interface with a vehicle computer (e.g., vehicle computer equipment 1316, described below in relation to FIG. 13) to perform the action. In some embodiments, the I/O circuitry receives the command to perform the action from the control circuitry 190 and interfaces with the vehicle computer.

The vehicle elements 128 include controls that assist in driving or in other functions that may need to be performed by the user (e.g., the driver of the vehicle 101), such as entertainment controls, lighting controls, and communication controls, to name a few examples. The control circuitry 190 may reside in or on the vehicle 101. The system 100 includes several applications to control the vehicle elements 128 based on an input. For example, the control circuitry 190, by running the system 100, processes computer-executable instructions to analyze the input from the steering wheel 102 and identify the action to control vehicle elements 128. The applications may be stored in a non-transitory memory (e.g., storage 1214, discussed below in relation to FIG. 12). The control circuitry 190 includes processing circuitry (e.g., processing circuitry 1210, discussed below in relation to FIG. 12) to process input to the control circuitry 190 (e.g., data and computer-executable instructions), store data to the non-transitory memory, and output results.

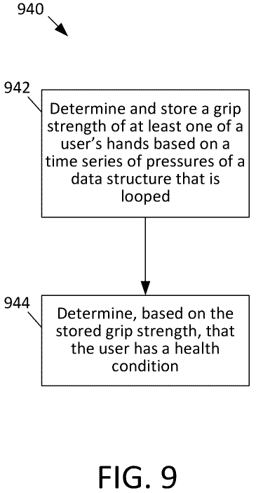

The instructions may be provided by the control circuitry 190 through the I/O circuitry 192 (e.g., I/O path 1216, discussed below in relation to FIG. 12). A vehicle element control application executes on the control circuitry 190, such as discussed below in relation to FIGS. 12 and 13, to provide instructions to the control circuitry 190 to perform the operations of process 140. The control circuitry 190 also executes a vehicle interface application, such as discussed below in relation to FIGS. 12 and 13, to continuously receive input from the steering wheel 102 or receive input from a vehicle control (e.g., via levers, dials, or knobs used to interface with the vehicle control), through the I/O circuitry 192. The control circuitry 190 also executes an input analysis application to associate input from the steering wheel 102 with the action to control vehicle elements 128. The control circuitry 190 may execute the input analysis application to train the system 100. The control circuitry 190 also executes a user profile management application to create, identify, and/or manage profiles for users. The control circuitry 190 may also execute a user health monitoring application, such as discussed below in relation to FIG. 9, to identify indications that a user is experiencing a health condition or predict that the user will experience the health condition. In some embodiments, the vehicle interface application interfaces with the other applications to carry out its functions.

The control circuitry 190 may use a plurality of sensors 104 disposed on the steering wheel 102 to monitor input to the steering wheel 102. The sensors 104 sense contact with the steering wheel 102, such as by a hand 108 of a user, and may be on the surface of the steering wheel 102, just below the surface, or embedded within the steering wheel 102. The sensors 104 are arranged into a plurality of zones 106 that wrap around the steering wheel 102. Each zone 106 is adjacent to two other zones 106. In the embodiment depicted in FIG. 1A, the steering wheel 102 is a round steering wheel having a circular rim and the zones 106 wrap around the entire circular profile of the rim. The sensors 104 are pressure sensors or transducers and may include any of a strain gauge, piezoelectric sensor, capacitive sensor, or optical pressure sensor, to name a few examples. The zones 106 are numbered from zone number 1 to 24 in a clockwise manner starting at a 12 o'clock position (as viewed on the page) and circling back to the 12 o'clock position. The zones 106 allow the control circuitry 190 to sense a grip on the steering wheel at multiple locations. For example, the user may grip the steering wheel anywhere along the profile of the rim of the steering wheel if the plurality of zones wrap around the entire rim. Although each of zones 106 is depicted as having one sensor 104, in some embodiments there are more than one sensor 104 per each of zones 106. The vehicle interface application executes on the control circuitry 190 to continuously receive data from the sensors 104.

Referring to FIG. 1B, the vehicle 101 includes the steering wheel 102, a blinker control lever 130, blinker indicator lights 131, a windshield wiper control lever 132, windshield wipers 133, infotainment system 134, infotainment and environment control knobs 136, and vents 138. The blinker control lever 130 may control the blinkers as indicated by the blinker indicator lights 131. The windshield wiper control lever 132 may control the windshield wipers 133. The infotainment and environment control knobs 136 may be used to control the infotainment system 134, such as volume, navigation, or app selection, and/or may be used to control the environment, such as a set temperature and fan speed of heating and cooling through the vents 138. The infotainment system 134 may also be controlled by a touch screen, and as shown, includes maps, music, vehicle information, and communication apps.

Returning to FIG. 1A, the process 140 continues to operation 144 with the control circuitry 190 prompting the user for a selection on whether to match a gesture input 110 to an action to control the vehicle elements 128. Gestures inputs 110 may include any input to the steering wheel 102 by the user (e.g., by hands 108) and may include tapping, swiping, squeezing, pinching, and dragging, to name a few examples. Gesture inputs 110 may be matched to actions in a training mode. The user may be prompted through a display screen of the vehicle 101, such as a vehicle instrument display, infotainment system display, or heads-up display, to name a few examples. In some embodiments, the user may be prompted through a display of a user device (e.g., wireless user communications device 1322, discussed below in relation to FIG. 13), such as a smartphone, tablet, or head mounted display, to name a few examples. In some embodiments, the user may be prompted using a voice command through a speaker of the vehicle 101 or the user device. In some embodiments, the control circuitry 190 prompts the user through the I/O circuitry 192. In such embodiments, the control circuitry 190 may provide the prompt by outputting data or commands to the I/O circuitry 192, and the I/O circuitry 192 communicates with a display screen of the vehicle 101.

The process 140 continues to operation 146 with the control circuitry 190 deciding whether a request to match a gesture input 110 to an action to control the vehicle elements 128 has been received. If the decision is no, then the process 140 continues to operation 156 discussed below in relation to FIG. 1B.

If the decision is yes, then the process 140 continues to operation 148 and begins the training mode with the control circuitry 190 prompting the user to perform a gesture input 110 to the steering wheel 102 to associate with an action to control the vehicle elements 128.

The gesture input 110 may include any movement of the hand 108 (e.g., left, right, or both hands) in relation to the steering wheel 102. For example, the gesture input 110 may include tapping the steering wheel 102, sliding or swiping part of the hand 108 across the steering wheel, twisting the hand 108 around a rim of the steering wheel 102, gripping, pinching, or pushing in on the rim of steering wheel 102, or loosening a grip on the steering wheel 102. The action to control the vehicle elements 128 may include functions that assist in driving or in other functions that may need to be performed by the user. For example, the action may include changing a music track, turning on a blinker, blowing the horn, or making a phone call to a particular person.

The process 140 continues to operation 150 with the I/O circuitry 192 receiving training data corresponding to the gesture input 110 from the sensors 104. The training data is continuously received from the sensors 104 while training the system 100 to associate an action to control the vehicle elements 128. The control circuitry 190 receives the training data from the I/O circuitry 192 (e.g., by executing the vehicle interface application) and determines a set of detected pressures over time (e.g., by executing the vehicle element control application) for each respective zone 106 of the zones 106 based on the training data and stored in a reference data structure 112. The set of detected pressures over time may be referred to as a time series of pressures of the reference data structure 112.

The control circuitry 190 treats the time series of pressures for each of zones 106 of the reference data structure 112 as adjacent to the time series of pressures of two other zones 106. For example, the control circuitry 190 may consider the time series of pressures for zone number 1 as adjacent to zone numbers 24 and 2 in the reference data structure 112. This allows a gesture input (e.g., gesture input 120 in FIG. 1B) that spans across zone numbers 24 and 1 (e.g., sliding a finger from zone number 24 to zone number 1) to be considered as a time series of pressures in one contiguous subset of the zones 106 instead of separate subsets of time series of pressures in zones 1 and 24.

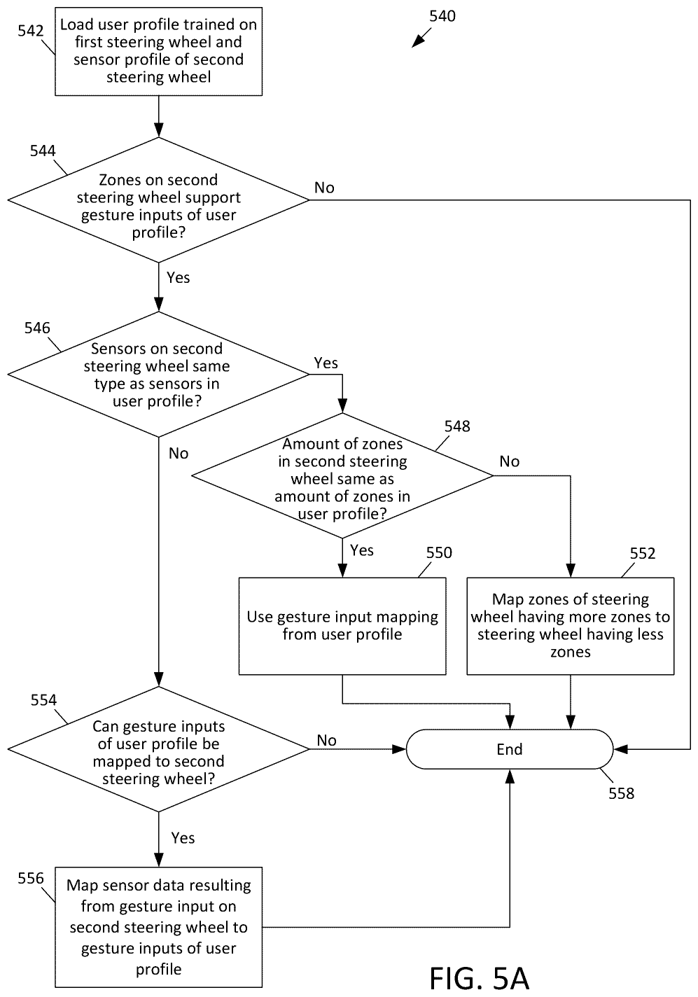

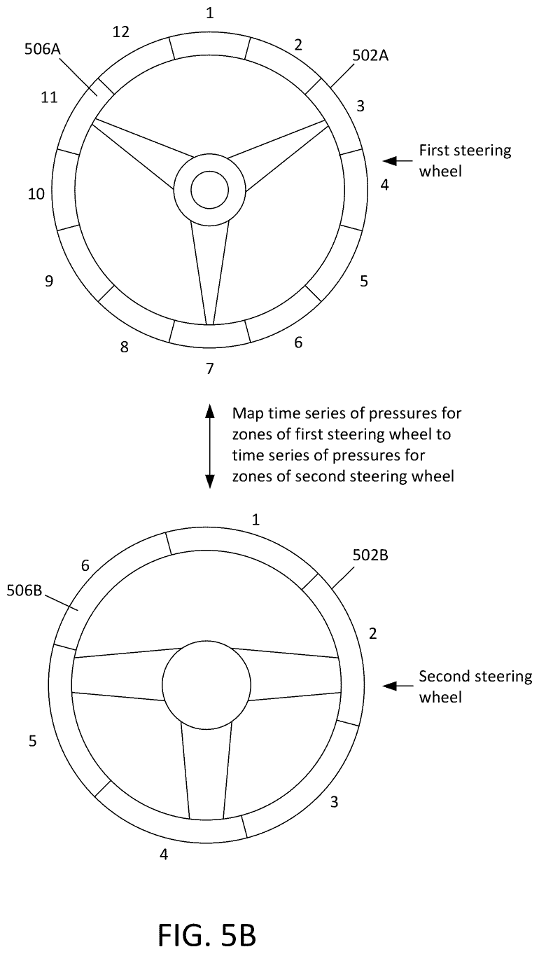

In some embodiments, the reference data structure 112 comprises a table where the last row is considered adjacent to the first row and each row contains the time series of pressures for a zone 106 of the plurality of zones 106. In such embodiments, the reference data structure 112 may comprise a table where each row contains a time series of pressures for a zone 106 of a plurality of training zones. The training zones may be the same as the zones 106, or different, such as described below in relation to FIG. 5B. In some embodiments, the reference data structure 112 comprises a datastore or other data structure. For example, the reference data structure 112 may comprise a collection where each element in the collection represents a time series of pressures for a zone 106 of the zones 106. The reference data structure 112 may include documents instead of tables. The reference data structure 112 may not include relational databases.

In the embodiment depicted in FIG. 1A, a right hand 108 grips the steering wheel 102 at a 3 o'clock position in zones 6, 7, and 8 and the gesture input 110 comprises sliding the index finger of the hand 108 along the profile of the rim of the steering wheel 102 from zone 6 at a time t1, away from the middle finger and into zone 5 at a time t2, and then back towards the middle finger to zone 6 at a time t3. The corresponding time series of pressures for zone 6 at times t1, t2, and t3 is a1, a2, and a3, respectively. The time series of pressures for zone 7 at the same times is b1, b2, and b3, while the time series of pressures for zone 8 is c1, c2, and c3. The time series of pressures for zone 5 at the same times is 0, d1, and 0.

For zone 5, d1 is greater than 0. For zone 6, a1 and a3 are both greater than a2. For zone 7, b1, b2, and b3 are approximately equal to one another since the fingers gripping these zones do not move during the gesture input 110. For example, b1, b2, and b3 may be within 10% of one another, such as within 5% of one another, such as within 2% of one another, such as within 1% of one another. For similar reasons, the time series of pressures c1, c2, and c3 in zone 8 are approximately equal to one another. The time series of pressures indicates a pressure change in zones 5 and 6 as the index finger moves during the gesture input 110. Thus, the time series of pressures in at least one zone 106 of the plurality of zones 106 may contain pressures that vary over time and correspond to contact with at least one of the user's hands (e.g., hand 108) and the steering wheel 102.

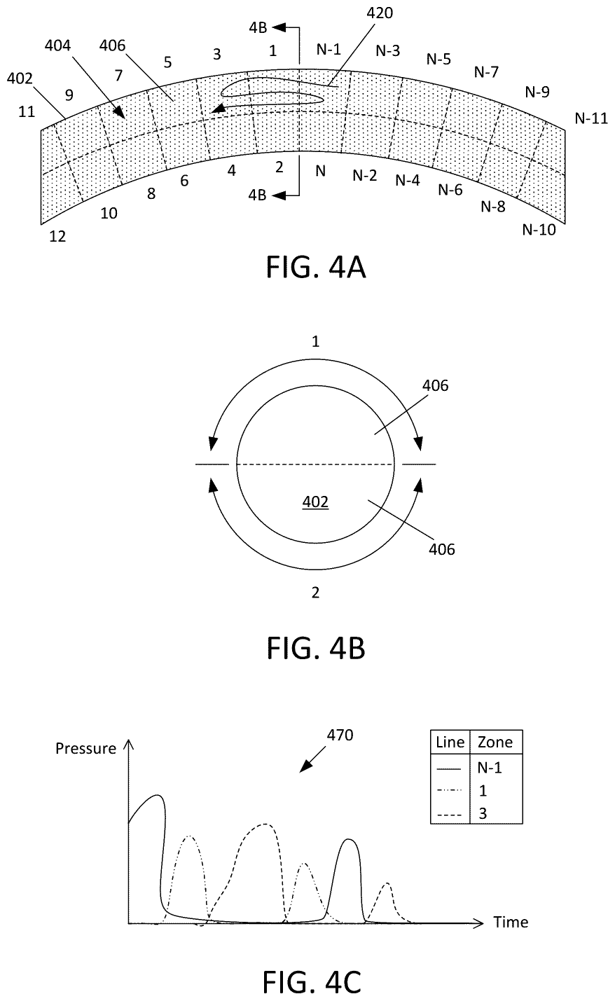

The time series of pressures for the zones 106 may differ based on the gesture input 110. For example, if the gesture input 110 is tapping, then the time series of pressures for a zone 106 may include a sequence of reductions and increases in pressure over time. If the gesture input 110 is pinching, then the time series of pressures for two zones 106 includes an increase and reduction in pressure at the same times. If the gesture input 110 is swiping, then the time series of pressures for adjacent zones 106 may include a sequence of increases and reductions in pressure over time, such as discussed in relation to FIG. 4C.

The control circuitry 190 determines the beginning and the end of the time series of pressures based on the gesture input 110. In some embodiments, the beginning of the time series of pressures is based on operation 148. For example, the beginning may be when the prompt is presented, or shortly after the prompt is presented to allow the user time to comprehend the prompt. In some embodiments, the end of the time series of pressures is based on a user input to the display of the vehicle 101 or user device or to a microphone of the vehicle 101 or user device.

The process 140 continues to operation 152 with the control circuitry 190 associating the time series of pressures of the reference data structure 112 with the action to control at least one element 128 of the vehicle 101. In some embodiments, the control circuitry 190, at this operation, executes the input analysis application, which is run by the control circuitry 190 to associate the time series of pressures with the action to control vehicle elements 128. The association may be included in the reference data structure 112, or as part of a separate lookup table, datastore, or other data structure. For example, the control circuitry 190 may store the action to control the at least one element 128 of the vehicle 101 with a reference link to the corresponding time series of pressures of the reference data structure 112. In the embodiment depicted in FIG. 1A, the action that the control circuitry 190 associates the time series of pressures with includes activating the right blinkers of the vehicle 101, as discussed in relation to FIG. 1B.

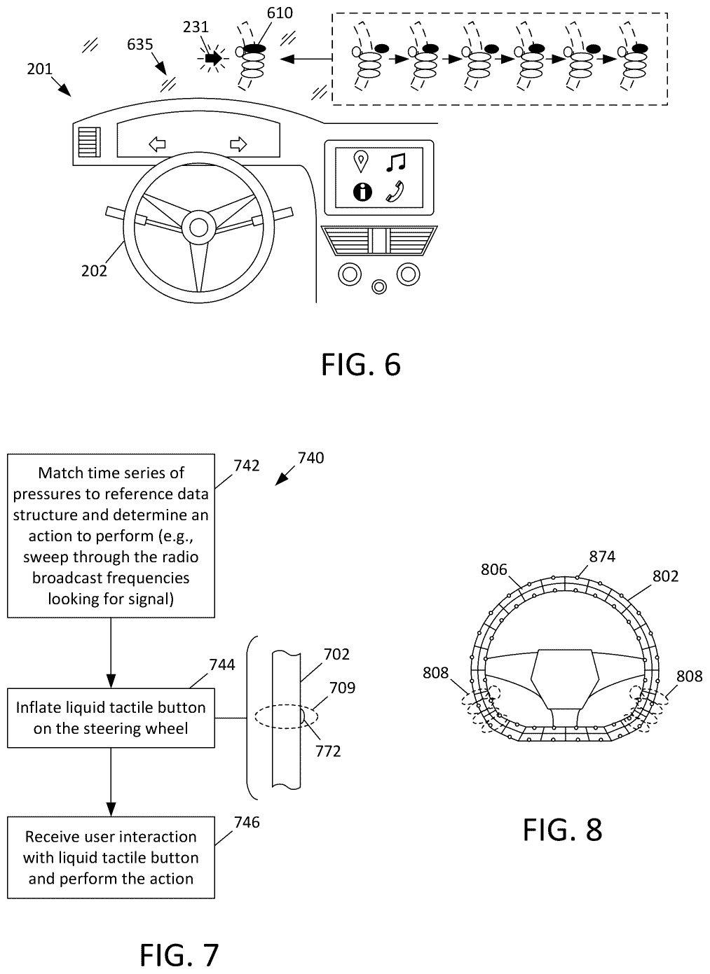

The control circuitry 190 may associate the action to control the at least one element 128 through several approaches. In one approach, at operation 146, the control circuitry 190 of the system 100 executes the input analysis application to receive a user input to inform the system 100 of the at least one element 128 and the corresponding action (e.g., right blinker and turn on). In some instances, this approach may only be performed when the vehicle 101 is in park or not moving. In another approach, the system 100 may present the at least one element 128 and the action to the user when requesting to match the gesture input 110. For example, the control circuitry 190 may execute the vehicle element control application to generate and send a command to the user to a heads-up display or user device, such as described below in relation to FIG. 6. In some instances, this appraoch may only be performed when the vehicle 101 is in park or not moving. In another approach, at operations 146 or 152, the control circuitry 190 receives a user input via the control of the vehicle 101 that would typically activate performance of the action to control the vehicle element 128 (e.g., by using the blinker control lever 130 to activate the right blinker), such as discussed below in relation to FIG. 1B. In some instances, this approach may be performed when the vehicle 101 is not in park or is moving.

In some embodiments, the control circuitry assigns a classification or genre to each action to control a vehicle element. For example, the genres may include actions to control mechanical operation of the vehicle 101, actions to control an entertainment system, actions to control a navigation system, actions to control a communication system, or actions related to a health of the user (as discussed in relation to FIG. 9), to name a few examples. The assignment may be determined by the control circuitry or through input by the user. In some embodiments, the control circuitry assigns the classification or genre to the gesture input 120.

In some embodiments, the control circuitry ranks each action to control a vehicle element. For example, the rankings may include critical, moderate, and low. In one example, a critical ranking may correspond to actions to control mechanical operation of the vehicle 101 (e.g., activate left or right turn signals) or actions related to safety of the vehicle 101 or the user. Moderate may include actions to control commonly used vehicle elements (e.g., turn on the radio) or vehicle elements commonly used by the user. Low may include vehicle elements that are not commonly used (e.g., activate cruise control) or that are available on a minority of vehicles 101. In some embodiments, the control circuitry may receive rankings from the user.

The process 140 continues to operation 154 with the control circuitry 190 deciding whether it is known that the gesture matching is complete. If the decision is no, and it is not known, then the process 140 returns to operation 144 with the control circuitry 190 prompting the user on whether to match an additional gesture to an action to control additional vehicle elements 128. For example, if a second gesture input is to be matched, a second gesture input is performed, the control circuitry 190 stores a second time series of data corresponding to the second gesture in the reference data structure 112, and the input analysis application associates the second time series of pressures with an action to control a second vehicle element 128. If the decision at operation 154 is yes, then the desired associations are made and the training mode is complete.

Referring to FIG. 1B, the process 140 continues to operation 156 in an operational mode with the control circuitry 190 monitoring data from the sensors 104, such as by executing the vehicle interface application. The control circuitry 190 receives the data from the I/O circuitry 192.

The process 140 continues to operation 158 with the I/O circuitry 192 continuously receiving data from the sensors 104. The control circuitry 190 receives the data from the sensors 104 and determines a time series of pressures for each respective zone 106 of the zones 106 based on the received data. The control circuitry 190 stores the determined time series of pressures in a data structure 122 that is looped. The time series of pressures for each zone 106 is treated as adjacent to the time series of pressures of two other zones 106. In the embodiment depicted in FIG. 1B, the time series of pressures is the result of a gesture input 120. The right hand 108 grips the steering wheel 102 at a 12 o'clock position in zone numbers 24, 1, and 2 and the gesture input 120 comprises sliding the index finger of the hand 108 along the profile of the rim of the steering wheel 102 from zone number 24 at time t4, away from the middle finger and into zone number 23 at time t5, and then back towards the middle finger to zone number 24 at time t6.

The corresponding time series of pressures at times t4, t5, and t6 for zone numbers 23, 24, 1, and 2 are as follows: zone number 23 is 0, h1, and 0; zone number 24 is e1, e2, and e3; zone number 1 is f1, f2, and f3; and zone number 2 is g1, g2, and g3. For the time series of pressures, h1 is greater than 0; e1 and e3 are greater than e2; f1, f2, and f3 are approximately equal to one another; and g1, g2, and g3 are approximately equal to one another. Thus, the time series of pressures indicates a pressure change in zone numbers 23 and 24 during the gesture input 120.

The process 140 continues to operation 160 with the control circuitry 190 deciding on whether the time series of pressures in the data structure 122 that is looped matches a time series of pressures in the reference data structure 112, such as by comparing the time series of pressures of the data structures 122 that is looped to the reference data structure 112. If the decision is no, then the process 140 continues to operation 156 to monitor the data from the sensors 104. In some embodiments, if the time series of pressures in the data structure 122 that is looped does not match a time series of pressures in the reference data structure 112, feedback may be presented to the user through the display screen of the vehicle or user device, through a voice command played through speakers of the vehicle or user device, through lights (e.g., lights 874, discussed below in relation to FIG. 8) on the steering wheel 102, or through haptic feedback from actuators (not shown) in the steering wheel 102 or user device. If the decision in operation 160 is yes, then the process 140 continues to operation 162 and the control circuitry 190 performs the action to control at least one element 128 of the vehicle 101 (e.g., activating the right blinker and corresponding right blinker indication light 131). In some embodiments, the control circuitry 190 sends commands to control the vehicle elements through the I/O circuitry 192.

The process 140 continues to operation 164 with the control circuitry 190 deciding on whether to continue monitoring data from the sensors 104. If the decision is yes, then the process 140 continues to operation 156 to monitor the data from the sensors 104. If the decision is no, then the process 140 continues to operation 166 and ends.

Referring back to operation 160, comparing the time series of pressures to determine if they match may require additional operations. In the embodiment depicted in FIGS. 1A and 1B, the time series of pressures of the data structure 122 that is looped is split over adjacent zone numbers 24 and 1. The data structure 122 is looped when comparing to the reference data structure 112 such that time series of pressures for adjacent zone numbers 23, 24, 1, and 2 are considered as a subset containing a contiguous time series of pressures resulting from the gesture input 120. The looping may occur before the comparison to the training data, such as part of a pre-processing operation, or as part of the comparison, such as by incrementally shifting which zone is the initial zone when comparing to the reference data structure 112.

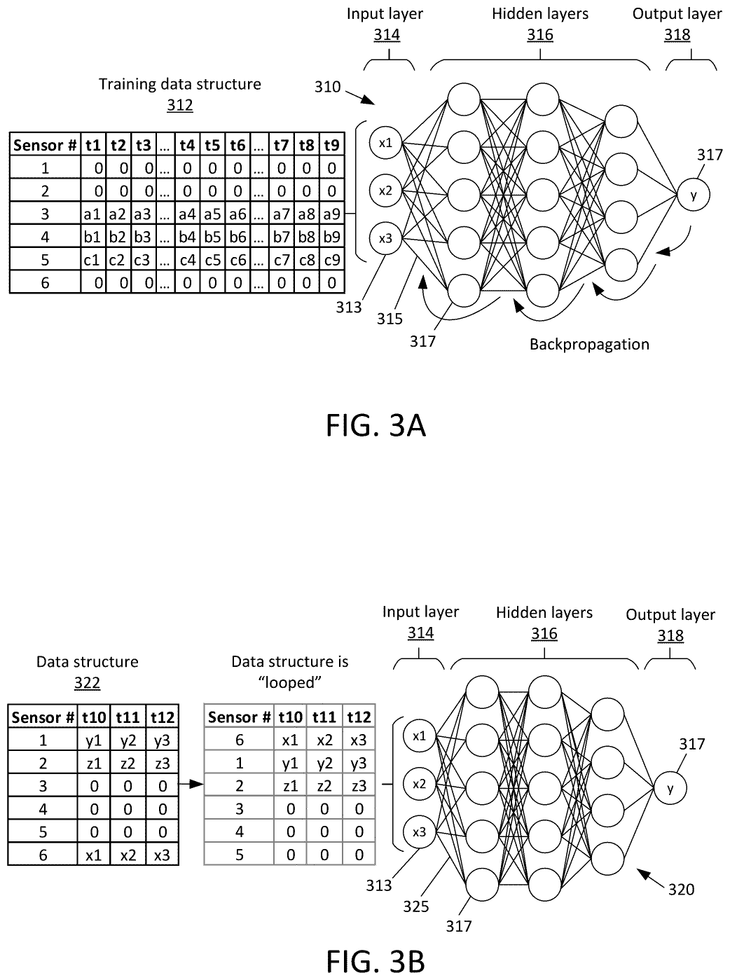

The control circuitry 190 may determine whether there is a match using different approaches. In some embodiments, the comparison is done using mathematical computations. For example, statistical methods, such as Student's t-test, Welch's T-Test, Mann-Whitney U test and an analysis of variance (ANOVA) to name a few examples, may be used to compare the time series of pressures of the data structure 122 that is looped to the time series of pressures of the reference data structure 112. In some embodiments, the comparison is done using a trained machine learning model, such as described below in relation to FIGS. 3A and 3B.

In some embodiments, the reference data structure 112 contains multiple, different time series of pressures corresponding to multiple, different actions to control the vehicle elements 128. In some embodiments, there is a reference data structure 112 corresponding to each action to control a vehicle element 128. In such embodiments, the data structure 112 that is looped may be compared to each reference data structure 112 until a match is found, or until compared to all reference data structures 112. In some embodiments, there are multiple reference data structures 112 and each data structure 112 corresponds to at least one action to control a vehicle element 128. In such embodiments, each data structure 112 may include similar gesture inputs (e.g., swipes, taps, or squeezes) or actions to similar vehicle elements 128 (e.g., lighting controls, infotainment system 134 controls, or environment controls).

In some embodiments, the data structure 122 that is looped comprises a table where the last row is considered adjacent to the first row and each row contains the time series of pressures for a zone 106 of the plurality of zones 106. In some embodiments, the data structure 122 that is looped comprises a datastore or other data structure.

In operation 160, the control circuitry 190 may determine a pattern in the time series of pressures of the table of the data structure 122 that is looped matches a pattern in the time series of pressures of the table of the reference data structure 112. The pattern in the time series of pressures of the data structure 122 that is looped may correspond to different row numbers than the pattern in the time series of pressures of the reference data structure 112.

In some embodiments, the control circuitry 190 processes the data structure 122 that is looped as a circular stack, ring buffer, or circular buffer. For example, at each time, the circular stack includes a pressure in each zone 106 and the last zone (e.g., zone number 24) in the buffer is connected to the first zone (e.g., zone 1). In some embodiments, the data structure 122 that is looped is a circular linked list where for each time, the last node (e.g., zone number 24) is connected to the first node (e.g., zone 1).

In some embodiments, the time series of pressures of the data structure 122 that is looped is used to identify a user. For example, each of two users that drive the vehicle 101 may grip the steering wheel at different locations and the control circuitry 190 identifies them as such (e.g., by executing the vehicle element control application). Once a user is identified, the control circuitry 190 identifies a corresponding user profile, e.g., by executing a user profile management application, and applies user-specific settings such as selecting the reference data structure 112 or adjusting seat position, mirror orientation, or other adjustments specific to the user. If the user is not identified, then the control circuitry 190 may create a user profile for the unidentified user by executing the user profile management application. The user profile is discussed below in relation to FIGS. 5A and 5B.

In some embodiments, the time series of pressures of the data structure 122 that is looped is used to activate safety features of the vehicle 101. For example, if the user squeezes the steering wheel with both hands for a predetermined period of time (as when bracing) or if the user gradually loosens their grip (as when falling asleep), then the control circuitry 190 may activate lane assist, speed limitations, or automatic braking.

In the embodiment depicted in FIGS. 1A and 1B, the time series of pressures of the data structure 122 that is looped, which results from the gesture input 120, matches the time series of pressures of the reference data structure 112, which results from the gesture input 110. Both time series of pressures have a pattern comprising a pressure change in adjacent zones and approximately equal pressures in each of two zones that are collectively adjacent to a zone undergoing the pressure change.

In the embodiment depicted in FIGS. 1A and 1B, times t1-t6 are sequential (e.g., t2 is at a later time than t1, t3 is at a later time than t2, and so forth). Times t1-t6 may not be evenly spaced apart. For example, the difference between t1 and t2 may be greater than the difference between t2 and t3.

In some embodiments, the gesture inputs 110 and 120 include different types of movement. For example, the gesture input 110 and 120 may include any combination of tapping, sliding, swiping, twisting, gripping, pinching, or pushing the steering wheel 102. In some embodiments, a single gesture input 110 and 120 may include contact with both a left and right hand 108 and the steering wheel. For example, the gesture input 110 and 120 may include a tap from the left hand 108, swipe from the right hand 108, and squeeze from both hands 108. In such embodiments, the time series of pressures for the zones 106 comprises pressures in two noncontiguous subsets of zones 106 that are higher than the remaining zones 106 of the zones 106. The two noncontiguous subsets of zones 106 may correspond to the left and right hands 108 of the user. In some embodiments, gesture inputs 110 and 120 may be coordinated with other gesture inputs. For example, gesture inputs 110 and 120 may swipe in a first direction to increase volume of the infotainment system 134. A different gesture input may swipe in a second direction opposite the first direction to turn down the volume. A similar approach may be used to “swipe through” songs of a playlist or radio stations.

In some embodiments there are more than one sensor 104 per zone 106. In such embodiments, the control circuitry 190 may average values of sensors 104 in a zone 106 to calculate a time series of pressures for the zone 106. In some embodiments, a location of each sensor 104 in each zone 106 is known. In such embodiments, the control circuitry 190 may average the values from sensors 104 in a zone 106 into one time series of pressures for the zone 106 and a location of the one time series of pressures within the zone 106 may be determined based on the values of the sensors 104 in the zone. For example, the values from the sensors 104 in the zone 106 may indicate the pressure is applied in a portion of the zone 106, such as near an edge of the zone. In such embodiments, the system 100 may determine if the corresponding gesture input moves within the same zone 106.

In some embodiments, the zones 106 may include areas of the steering wheel 102 other than the rim. For example, the zones 106 may extend on spokes or a steering cap of the steering wheel 102.

In some embodiments, the sensors 104 may comprise vibration sensors, accelerometers, gyroscopes, eddy current sensors, capacitive displacement sensors, or skin conductivity sensors. In such embodiments, the sensors may be used to determine contact with at least one of the user's hands (e.g., hand 108) and the steering wheel 102. In some embodiments, such as later discussed in relation to FIG. 9, the sensors 104 may comprise health sensors such as skin temperature sensors, heart rate sensors, non-invasive glucose monitoring sensors, or sensors to track volatile organic compounds (VOCs) in bodily emissions such as perspiration.

FIG. 2 is a schematic illustration of a process 240 of training a system 200 for receiving input on a steering wheel 202 of a vehicle 201 to control vehicle elements 128 of the vehicle 201, in accordance with embodiments of the disclosure. The process 240 shown in FIG. 2 may be implemented, in whole or in part, by one or more systems or devices described herein.

The system 200 includes a steering wheel 202 comprising a plurality of sensors 204 arranged in a plurality of zones 206, control circuitry 290, and I/O circuitry 292. The I/O circuitry 292 receives data from the sensors 204. The control circuitry 290 determines a time series of pressures for each of the zones 206 based on the data from the sensors 204. The vehicle 201 includes the steering wheel 102, a blinker control lever 230, and blinker indicator lights 231.

The process 240 begins a training mode at operation 242 with the control circuitry 290 prompting a user to perform a gesture input (e.g., gesture input 110 in FIG. 1A). The gesture input will be associated with an action to control the vehicle elements 228, but at operation 242 the system 100 is not aware of the action.

The process 240 continues to operation 244 with the I/O circuitry 292 receiving training data corresponding to the gesture input from the sensors 204. The control circuitry 290 processes the received training data and determines and stores the time series of pressures for each of the zones 206 in a reference data structure (e.g., reference data structure 112 in FIG. 1A).

The process 240 continues to operation 246 with the control circuitry 290 prompting the user to perform an action to control the vehicle elements 228. In the embodiment depicted in FIG. 2, the user responds to the prompt by moving the blinker control lever 230 to activate the right blinkers of the vehicle 201 and corresponding blinker indicator light 231.

The process 240 continues to operation 248 with the control circuitry 290 associating the time series of pressures of the reference data structure with the action to control the vehicle elements 228.

In some embodiments, the process 240 may be used to train the system 100 while the user is operating the vehicle 201. Performing the action to control the vehicle elements 228 as part of the training mode may feel more natural to the user and allow the user to operate the vehicle during training.

In some embodiments, operation 246 may be performed before either of operations 242 or 244.

In some embodiments, operations 242, 244, 246, and 248 may be used instead of operations 148, 150, and 152 discussed in relation to FIG. 1A.

FIG. 3A shows a schematic illustration of training a machine learning (ML) model to associate a time series of pressures with an action to control an element of a vehicle, in accordance with embodiments of the disclosure. In particular, FIG. 3A shows a deep neural network (DNN) 310 as the ML model. Control circuitry (e.g., control circuitry 190, 290, in FIGS. 1A and 2 or control circuitry 1212 discussed below in relation to FIG. 12) may train the DNN 310 (e.g., by executing an input analysis application).

A training data structure 312 contains a time series of pressures for training the DNN 310. The training data structure 312 may be a reference data structure (e.g., reference data structure 112 in FIG. 1A) that is used by the control circuitry to train the DNN 310. The DNN 310 accesses the time series of pressures of the training data structure 312 and a corresponding desired action to control at least one element of the vehicle. Each of the time series of pressures of the training data structure 312 corresponds to a zone of a steering wheel (e.g., steering wheel 102 in FIG. 1A). In the embodiment depicted in FIG. 3A, the training data structure 312 includes a time series of pressures for three gesture inputs. A first gesture input is shown at times t1 through t3, a second gesture input is shown at times t4 through t5, and a third gesture input is shown at times t6 through t9. The first through third gesture inputs are the same gesture input repeated three times.

The DNN 310 includes an input layer 314, hidden layers 316, an output layer 318, and synapses 315 connecting the layers 314, 316, and 318. The input layer 314 comprises independent input variables 313 shown as x1, x2, and x3, although more or less input variables 313 may be used depending on the input data. For example, x1 may be the time series of pressures from a first zone, x2 may be the time series of pressures from a second zone, and x3 may be the time series of pressures from a third zone. In the embodiment depicted in FIG. 3A, the time series of pressures of the training data structure 312 is inputted into the DNN 310 through the input layer 314. For example, the pressures for each zone at each time (e.g., t1, t2, and t3) are entered into the DNN 310 as the input variables 313 and may be input as a circular stack or a circular linked list. Synapses 315 connect the input variables 313 to neurons 317 in a first hidden layer 316 of the hidden layers 316. Each neuron 317 in the first hidden layer 316 calculates an output value that is passed to each neuron 317 of the next hidden layer 316 through a synapse 315. This process is repeated until the output of each neuron 317 of the last hidden layer 316 passes through a synapse 315 to the neuron 317 of the output layer 318. The output layer 318 calculates the output of the DNN 310, shown as y, which is a determined action to control a vehicle element (e.g., vehicle elements 128 and 228 in FIGS. 1A and 2, respectively).

The DNN 310 calculates its output as follows. Each synapse 315 has an associated weight. Each input variable 313 of the input layer 314, in top-to-bottom order (as shown on the page), passes its value with the weight of the corresponding synapse 315 to each neuron 317 of the first hidden layer 316. Each neuron 317 multiplies each of the values of the input layer 314 (e.g., x1, x2, and x3) with the weight of the synapse 315 connecting the value to the neuron 317, sums the multiplied values, applies its activation function to this sum, and outputs a value computed by the activation function to neurons 317 of the next hidden layer 316. The output value of each neuron 317 of the first hidden layer 316 is passed with a weight of a corresponding synapse 315 to each neuron 317 of the next hidden layer 316, which applies its activation function to calculate its output value. This process is repeated until the neuron 317 of the output layer 318 calculates the output of the DNN 310.

The control circuitry trains the DNN 310 through backpropagation. The control circuitry adjusts the DNN 310 by comparing the output of the DNN 310 to the desired output through a loss function or cost function. The control circuitry uses backpropagation to perform a backward pass to adjust the DNN 310 by changing the weights of the synapses 315 to minimize the loss/cost function. The output layer 318 calculates the output of the DNN 310 using the updated weights, and the new output of the DNN 310 is compared to the desired output. The backpropagation is repeated until the loss/cost function is minimized, at which point the DNN 310 with its corresponding weights is considered a trained DNN 320 as discussed with respect to FIG. 3B.

FIG. 3B shows a schematic illustration of using a trained ML model to compare a time series of pressures of a data structure that is looped to a time series of pressures of a training data structure, in accordance with embodiments of the disclosure. In particular, FIG. 3B shows the trained DNN 320 as the trained ML model. The control circuitry may use the trained DNN 320 (e.g., by executing an input analysis application).

The trained DNN 320 includes the input layer 314, hidden layers 316, the output layer 318, and “trained” synapses 325 connecting the layers 314, 316, and 318. The trained synapses 325 include the weights calculated during backpropagation as discussed above with respect to FIG. 3A. A data structure 322 that is looped contains a time series of pressures for each zone of a steering wheel (e.g., steering wheel 102 in FIG. 1B) that corresponds to a gesture input from time t10 to time t12. In the embodiment depicted in FIG. 3B, the gesture input from time t10 to time t12 is similar to the gesture input discussed in relation to FIG. 3A, but is performed on different zones of the steering wheel.

The control circuitry 190 inputs the time series of pressures into the trained DNN 320 through the input layer 314, such as a circular stack or a circular linked list. The neurons 317 of the hidden layers 316 and output layer 318 uses the weights of each connecting trained synapse 325 and applies their activation function to calculate the output of the trained DNN 320. Since the time series of pressures in the data structure 322 that is looped matches the time series of pressures in the training data structure 312, the output of the trained DNN 320 is the action to control the vehicle element as discussed above with respect to FIG. 3A. However, if the trained DNN 320 does not recognize the time series of pressures in the data structure 322 that is looped, then the trained DNN 320 may generate an output that indicates so and no action to control a vehicle element results.

The DNN 310 may be trained using time series of pressures corresponding to one-handed or two-handed gesture inputs. The trained DNN 320 is capable of using a time series of pressures corresponding to gesture inputs performed using separate fingers across two hands while not being prescriptive about the separation or distance between the two hands.

In the embodiments depicted in FIGS. 3A and 3B, a certain number of input variables 313, neurons 317, and hidden layers 316 are shown for illustrative purposes. The DNN 310 and trained DNN 320 may have a different number of input variables 313, neurons 317, and hidden layers 316 than what is shown. In some embodiments, the output layer 318 may have a neuron for each action to control a vehicle element. In such embodiments, the neuron in the output layer 318 having the highest value may be identified as the action to control the vehicle element.

In the embodiments depicted in FIGS. 3A and 3B, each input variable 313 is connected to each neuron 317 of the first hidden layer 316, each neuron 317 in the hidden layers 316 is connected to another neuron 317 in a subsequent hidden layer 316, and each neuron 317 of the last hidden layer 316 is connected to the neuron 317 of the output layer 318. In some embodiments, not every input variable 313 connects to each neuron 317 of the first hidden layer 316. For example, an input variable 313 may only connect to three of five neurons 317 of the first hidden layer 316. In some embodiments, not every neuron 317 in a preceding hidden layer 316 connects to each neuron 317 of the next hidden layer 316.

In some embodiments, the DNN 310 is a recurrent neural network (RNN). RNNs use sequential data or time series data and take information from prior inputs to influence a current input layer 314 and output layer 318.

In some embodiments, a different ML model may be used. For example, the ML model may be a shallow neural network having one or two hidden layers 316.

FIG. 4A shows an illustration of a gesture input to a steering wheel 402 having a plurality of zones 406, in accordance with embodiments of the disclosure. FIG. 4B shows a side sectional illustration of the steering wheel of FIG. 4A, in accordance with embodiments of the disclosure. Therefore, FIGS. 4A and 4B are herein described together for clarity.

Referring to FIG. 4A, the steering wheel 402 may be part of a system for receiving input on the steering wheel 402, such as system 100 discussed above with respect to FIGS. 1A and 1B. The steering wheel 406 has “N” number of zones 406 and a plurality of sensors 404 are located within each zone 406. The data from the sensors 404 in each zone 406 is averaged to determine the time series of pressure for each zone 406. The zones 406 are numbered from zone 1, which is immediately left of a 12 o'clock position on the steering wheel 402, to zone “N,” which is immediately right of the 12 o'clock position. Referring to FIGS. 4A and 4B, the steering wheel 420 has different zones 406 for an outer portion of the rim than the inner portion of the rim. As shown, zone number 1 is on an outer half of the rim of the steering wheel 402 and zone number 2 is on the lower half of the steering wheel. Zone number 3 is on the outer portion of the rim and zone 4 is on the inner portion of the rim, and so forth. This results in two zones per radial position on the steering wheel 402, which may result in finer detail in the resulting time series of pressures. Thus, the zones 406 wrap around a profile of the steering wheel 402 and wrap around a cross-section or grip portion of the rim of the steering wheel 402.

Referring back to FIG. 4A, a gesture input 420 travels across a subset of the zones 406 which includes zones “N−1”, 1, and 3. The gesture input travels from zone “N−1,” across zone 1, and to zone 3. Then back across zone number 1 to zone number “N−1.” Then back across zone number 1 to zone number 3. This gesture input 420 results in a time series of pressures for zones “N−1”, 1, and 3 that is shown in FIG. 4C.

FIG. 4C shows a plot 470 of a time series of pressures for zones 406 of the steering wheel 402 corresponding to the gesture input 420 of FIG. 4A, in accordance with embodiments of the disclosure.

The time series of pressures for the zones 406 (e.g., zones “N−1,” 1, and 3) are shown on the same plot. As the gesture input 420 travels through each zone, the pressure increases and then decreases as the gesture input 420 leaves the zone. Thus, a pressure change occurs in the time series of data each time the gesture input 420 enters and leaves a zone.

Although not shown in FIG. 4C, if a user gripped the steering wheel 402 (FIG. 4A) and did not move the finger that was gripping the steering wheel, the resulting time series of pressures would show in the plot 470 (FIG. 4C) as an approximately constant pressure, which may vary slightly with sensor tolerance or if the user makes small movements with their hand or fingers.

FIG. 5A is a schematic illustration of a process of mapping a user profile trained on a first steering wheel (e.g., first steering wheel 502A, discussed below in relation to FIG. 5B) to data from sensors (e.g., sensors 104, 204, 404, 1004 discussed in relation to FIGS. 1A and 1B, 2, 4, and 10) of a second steering wheel (e.g., second steering wheel 502B, discussed below in relation to FIG. 5B), in accordance with embodiments of the disclosure. The process 540 shown in FIG. 5A may be implemented, in whole or in part, by one or more systems or devices described herein.

The process 540 begins at operation 542 with control circuitry (e.g., control circuitry 190 and 290 in FIGS. 1A and 2 and control circuitry 1212, discussed below in relation to FIG. 12) loading the user profile trained on the first steering wheel and a sensor configuration of the second steering wheel. The control circuitry may execute a user profile management application to load the user profile. The user profile includes information associating gesture inputs (e.g., gesture input 120, 420 in FIGS. 1B and 4 and gesture input 610, discussed below in relation to FIG. 6) to the first steering wheel to an action to control vehicle elements (e.g., vehicle elements 128, 228 in FIGS. 1A and 2 and vehicle elements 1204, discussed below in relation to FIG. 12). For example, the user profile may include a time series of pressures for each zone (e.g., zones 106, 206, 406 in FIGS. 1, 2, and 4, and zones 506A and 506B, 806, 1006 discussed below in relation to FIGS. 5B, 8, and 10) of the first steering wheel and an associated action to control vehicle elements, such as discussed in relation to FIG. 1A. The user profile may contain a trained ML model (e.g., trained DNN 320 in FIG. 3B) that associates gesture inputs, or the corresponding time series of pressures, to an action to control vehicle elements, such as discussed in relation to FIGS. 3A and 3B. The sensor configuration includes information about the sensors of the second steering wheel and may include types of the sensors (e.g., pressure sensors, skin conductivity sensors, vibration sensors, or health sensors), layout of sensors in relation to the zones, or the distribution or density of each sensor type on the steering wheel or in each zone. In some embodiments, the control circuitry receives the user profile and the sensor configuration through I/O circuitry (e.g., I/O circuitry 192 and 292 in FIGS. 1A and 2 and I/O path 1216, discussed below in relation to FIG. 12).

The process 540 continues to operation 544 with the control circuitry deciding whether the zones on the second steering wheel support the gesture inputs of the user profile. For example, the control circuitry determines whether the second steering wheel supports any of the gesture inputs of the user profile. A gesture input may be supported if it may be performed on the second steering wheel or if it may be mapped to the second steering wheel. In some embodiments, the control circuitry may decide if the time series of pressures associated with the actions to control vehicle elements may be reproduced on the second steering wheel. In some embodiments, the control circuitry decides whether the distribution or density of the sensors in the second steering wheel meet a minimum threshold, for example, to support the gesture inputs.

In some embodiments, the control circuitry decides if gesture inputs to perform actions to control a certain classification or genre of vehicle elements, such as discussed in relation to FIG. 1A, are supported by the second steering wheel. For example, the control circuitry may decide if the second steering wheel supports all gesture inputs to control mechanical operation of a vehicle (e.g., vehicle 101 in FIG. 1B and vehicle 201 in FIG. 2 and below in FIG. 6). In some embodiments, the gesture inputs of the user profile are ranked, such as discussed in relation to FIG. 1A, and the control circuitry decides whether gesture inputs meeting a certain ranking threshold are supported by the second steering wheel. For example, the control circuitry may decide if the second steering wheel supports all gesture inputs having a ranking of critical.

If the decision at operation 544 is no, then the process 540 ends at operation 558 and the control circuitry informs a user that the user profile cannot be used with the second steering wheel. The control circuitry may inform the user through a display screen of the vehicle, a display screen of a user device (e.g., wireless user communications device 1322, discussed below in relation to FIG. 13), or a voice command played through speakers of the vehicle or user device, such as discussed in relation to FIG. 1A, to name a few examples. In some embodiments, the control circuitry provides additional details to the user. For example, the control circuitry may inform the user that gesture inputs of the user profile cannot be used with the second profile or that the distribution or density of the sensors of the second steering wheel is not compatible with the user profile.

If the decision in operation 544 is yes, then the process 540 continues to operation 546 with the control circuitry deciding whether sensors on the second steering wheel are the same type as sensors in the user profile.

If the decision is no, then the process 540 continues to operation 548 with the control circuitry deciding whether the amount of zones in the second steering wheel are the same as the amount of zones in the user profile. In some embodiments, the control circuitry determines whether the distribution or density of sensors in the second steering wheel is the same as in the first steering wheel. If the decision in operation 548 is yes, then the process 540 continues to operation 550 with the control circuitry using the gesture inputs from the user profile. The process 540 ends at operation 558 and the control circuitry informs the user that the user profile and corresponding gesture inputs are being used.

If the decision in operation 548 is no, then the process 540 continues to operation 552 with the control circuitry mapping the zones of the steering wheel having more zones to the steering wheel having less zones, such as discussed below in relation to FIG. 5B. In some embodiments, the time series of pressures of the steering wheel having more zones is mapped to the steering wheel having less zones. The process 540 ends at operation 558 and the control circuitry informs the user that the user profile is being used and some of the corresponding gesture inputs may change (e.g., a swipe input gesture becomes a series of taps). In some embodiments, the control circuitry informs the user of the changed gesture input using “hints,” which may be presented through a display screen of the vehicle or a user device, through a voice command played through speakers of the vehicle or user device, through lights (e.g., lights 874, discussed below in relation to FIG. 8) on the second steering wheel, or through haptic feedback from actuators in the second steering wheel or user device, to name a few examples. The control circuitry may use any relevant file format, such as XML, to present the changed gesture input. In some embodiments, the control circuitry prompts the user to perform a changed gesture input to map to a gesture input of user profile.

If the decision in operation 546 is no, the process 540 continues to operation 554 with the control circuitry deciding whether the gesture inputs of the user profile can be mapped to the second steering wheel. In some embodiments, the control circuitry decides whether the time series of pressures of the user profile can be mapped to gesture inputs on the second steering wheel. In some embodiments, the control circuitry decides if the second steering wheel supports gesture inputs to perform actions to control certain genres of vehicle elements. For example, the control circuitry may determine if gesture inputs to control an entertainment system or a communication system of the vehicle are supported. In some embodiments, the control circuitry decides if the second steering wheel supports certain rankings of gesture inputs from the user profile. For example, the control circuitry may determine if gesture inputs ranked as moderate and above are supported. If the decision in operation 554 is no, then the process 540 ends at operation 558 and the control circuitry informs the user that the user profile cannot be used with the second steering wheel. In some embodiments, the control circuitry informs the user as to why the second steering wheel does not support the user profile.

If the decision in operation 554 is yes, then the process 540 continues to operation 556 with the control circuitry mapping sensor data resulting from gesture inputs on the second steering wheel to gesture inputs of the user profile. For example, if the first steering wheel includes pressure sensors and the second steering wheel includes skin conductivity sensors, then the sensor data from the skin conductivity sensors is mapped to the data from the pressure sensors. In some embodiments, the pressure sensors may sense a range of pressure values and the skin conductivity sensors may sense a binary contact or no contact. Certain gestures, such as a squeeze on the first steering wheel, may be remapped to a different gesture input compatible with the skin conductivity sensors (e.g., a tap or series of taps). The mapping may be similar to the mapping discussed in relation to operation 552. In some embodiments, the control circuitry informs the user of the changed gesture input. In some embodiments, the control circuitry prompts the user to perform a changed gesture input. In some embodiments, the sensor data of the second steering wheel is mapped to the time series of pressures of the user profile.

The process 540 ends at operation 558 and the control circuitry informs the user that the user profile is being used and some of the corresponding gesture inputs may have been changed. In some embodiments, the control circuitry informs the user of the changed gesture inputs.

FIG. 5B shows a schematic illustration of mapping a user profile containing an ML model (e.g., trained DNN in FIG. 3) trained on a first steering wheel 502A to a second steering wheel 502B, in accordance with embodiments of the disclosure.

The first steering wheel 502A has twelve zones 506A and the second steering wheel 502B has six zones 506B. The zones 506A are positioned such that zone number 1 starts at the 11:30 o'clock position and ends at the 12:30 o'clock position, zone number 2 starts at the 12:30 o'clock position and ends at the 1:30 o'clock position, and so forth. The zones 506B are positioned such that zone number 1 starts at the 11:30 o'clock position and ends at the 1:30 o'clock position, zone number 2 starts at the 1:30 o'clock position and ends at the 3:30 o'clock position, and so forth. Zone numbers 1 and 2 on the first steering wheel 502A map to zone number 1 on the second steering wheel 502B, zone numbers 3 and 4 on the first steering wheel 502A map to zone number 2 on the second steering wheel 502B, and so forth.

Control circuitry (e.g., control circuitry 190 and 290 in FIGS. 1A and 2 and control circuitry 1212, discussed below in relation to FIG. 12) trains the ML model of the user profile to associate different time series of pressures with actions to control different vehicle elements (e.g., vehicle elements 128 and 228 in FIGS. 1A and 2). The user may wish to port their user profile to a vehicle having the second steering wheel 502B. Since the second wheel 502B has less zones 506B than the first steering wheel 502A, the control circuitry maps the time series of pressures of the zones 506B, when possible, to the zones 506A. For example, a time series of pressures having a pressure change between zones 1 and 2 of the steering wheel 502B would map a time series of pressures having a pressure change between zones 2 and 3 of the first steering wheel 502A. If the time series of pressures cannot be directly mapped, such as if there were a pressure change between zones 1 and 2 of the first steering wheel 502A, then the control circuitry may suggest or request a different time series of pressures, such as a sequence containing a decrease and increase in pressure to zone number 1 of steering wheel 502B (e.g., by tapping on zone number 1 of the second steering wheel 502B).

FIG. 6 shows an illustration of a heads-up display for presenting a gesture input 610 sequence to a user, in accordance with embodiments of the disclosure.

The heads-up display projects the gesture input 610 sequence on a windshield 635 of the vehicle 201. The gesture input 610 sequence may be presented to the user during a training mode, such as in operation 242 discussed in relation to FIG. 2. The gesture input 610 sequence may include a sequence of actions to perform, such as gripping the steering wheel 202 with a right hand and lifting an index finger off the steering wheel 202 to tap the steering wheel 202 three times. The heads-up display may also present a corresponding action to control at a vehicle element, such as activation of the right blinker indicator light 231, to inform the user the result of the gesture input 610 sequence. Control circuitry (e.g., control circuitry 190, 290, in FIGS. 1A and 2 or control circuitry 1212 discussed below in relation to FIG. 12) may generate and send the gesture input 610 sequence for display (e.g., by executing a vehicle element control application).

In some embodiments, the gesture input 610 sequence includes different types of gesture inputs 610. For example, the gesture input 610 sequence may include any combination of tapping, sliding, swiping, twisting, gripping, pinching, or pushing.

In some embodiments, the heads-up display presents the gesture input 610 sequence to the user through an augmented reality or virtual reality device.

FIG. 7 is a schematic illustration of a process 740 for presenting a liquid tactile button 772 for receiving an input to a steering wheel 702, in accordance with embodiments of the disclosure. The process 740 shown in FIG. 7 may be implemented, in whole or in part, by one or more systems or devices described herein. The steering wheel 702 includes at least one liquid tactile button 772, which may be inflated to protrude from the steering wheel 702, or deflated to recede into the steering wheel 702.

The process 740 begins at operation 742 with control circuitry (e.g., control circuitry 190, 290 in FIGS. 1A and 2 and control circuitry 1212, discussed below in relation to FIG. 12) matching a time series of pressures of a data structure (e.g., data structure 122, 322 in FIGS. 1B and 3B) that is looped to a time series of pressures of a training data structure (e.g., training data structure 112, 312 in FIGS. 1A and 3B) to determine an action to control a vehicle element (e.g., vehicle elements 128 and 228 in FIGS. 1A and 2), such as described in relation to FIG. 1B. The time series of pressures of the data structure that is looped results from a gesture input (e.g., gesture input 120, 420, 610 in FIGS. 1B, 4, and 6). The action to control a vehicle element may include sweeping or scanning through radio broadcast frequencies to look for a signal or through a playlist to find a song.

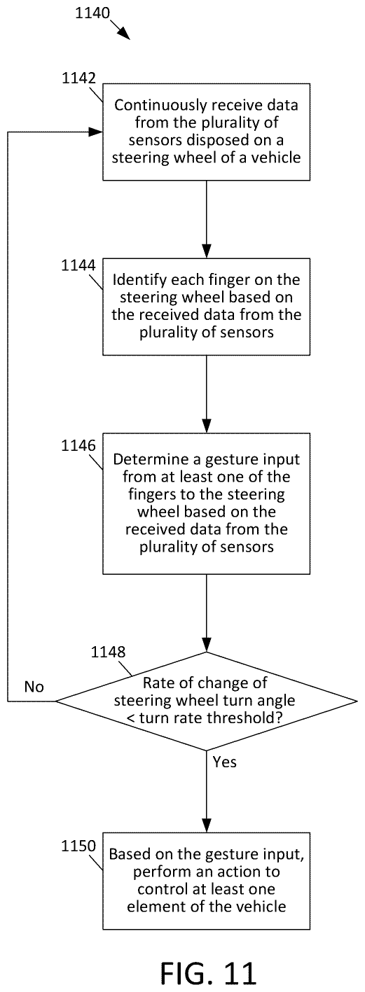

The process 740 continues to operation 744 with the control circuitry inflating the liquid tactile button 772 on the steering wheel 702 to allow a finger 709 of a user's hand (e.g., hands 108 in FIGS. 1A and 1B) to press the liquid tactile button 772 to perform the action. In some embodiments, the steering wheel comprises a plurality of liquid tactile buttons 772. In such embodiments, the control circuitry may determine the liquid tactile button 772 closest to the finger 709 and inflate it, allowing the user to place their hands anywhere on the rim of the steering wheel 702. In some embodiments, the control circuitry identifies the finger 709 at a zone (e.g., zones 106, 206, 406, 506A and 506B in FIGS. 1, 2, 4, and 5B) having a highest magnitude pressure in the time series of pressures of a data structure (e.g., data structure 122, 322 in FIGS. 1B and 3B) that is looped or a zone having the last pressure in the time series of pressures. In some embodiments, the control circuitry identifies the finger 709 as a specific finger of the hand, such as discussed below if relation to FIG. 11, and inflates the liquid tactile button 772 based on identifying the finger 709. For example, the control circuitry may inflate the liquid tactile button 772 closest to an index finger.

The process 740 continues to operation 746 with the control circuitry receiving user interaction with the liquid tactile button 772 and performing the action based on the user interaction. For example, the liquid tactile button 772 allows the user to continue sweeping through radio stations or a playlist by pressing the liquid tactile button 772 as many times as needed to find an acceptable broadcast (e.g., a radio station) or song. This may be easier than performing a gesture input each time to scan for a new radio station or a new song. Once a satisfactory radio station or song is found, the gesture input may be repeated to deflate the liquid tactile button 772, or the liquid tactile button 772 may deflate if no user interaction is received for a threshold time period. The control circuitry may execute a vehicle element control application to inflate and deflate the liquid tactile button 772, and to determine whether the user has interacted with the liquid tactile button 772. In some embodiments, the control circuitry may interface with I/O circuitry (e.g., I/O circuitry 192 and 292 in FIGS. 1A and 2 and I/O path 1216, discussed below in relation to FIG. 12) to inflate and deflate the liquid tactile button 772.

In some embodiments, the control circuitry inflates the liquid tactile button 772 to provide tactile feedback to the user. For example, when using a navigation system, the liquid tactile button 772 may pulsate, e.g., under a finger 709 of the right hand, to indicate an upcoming turn, e.g., a right turn.

FIG. 8 shows an illustration of a lights 874 in a steering wheel 802 to present a gesture input sequence (e.g., gesture input 120, 420, 610 in FIGS. 1B, 4, and 6) to a user, in accordance with embodiments of the disclosure.

The steering wheel 802 includes zones 806. The user may grip the steering wheel 802 with their hands 808. Control circuitry (e.g., control circuitry 190, 290 in FIGS. 1A and 2 and control circuitry 1212, discussed below in relation to FIG. 12) may illuminate the lights 874 during a training mode, such as in operation 242 discussed in relation to FIG. 2, to guide the user to input a gesture input. For example, a light 874 in a zone 806 may flash on and off three times to guide the user to tap the zone three times. Lights 874 in adjacent zones 806 may be alternatively illuminated a number of times to guide the user to slide a finger between the adjacent zones 806. In some embodiments, the control circuitry executes an input analysis application to illuminate the lights 874. In some embodiments, the lights 874 are illuminated to show the user where the zones 806 are located.

FIG. 9 shows a schematic illustration of determining a health condition based on inputs to a steering wheel (e.g., steering wheel 102 in FIGS. 1A and 1B, steering wheel 202 in FIGS. 2 and 6, steering wheel 402 in FIGS. 4A and 4B, and steering wheel 702 and 802 in FIGS. 7 and 8), in accordance with embodiments of the disclosure. The process 940 shown in FIG. 9 may be implemented, in whole or in part, by one or more systems or devices described herein.

The process 940 begins at operation 942 with control circuitry (e.g., control circuitry 190 and 290 in FIGS. 1A and 2 and control circuitry 1212, discussed below in relation to FIG. 12) determining a grip strength of at least one of a user's hands (e.g., hands 108, 808 in FIGS. 1A and 1B and 8), based on a time series of pressures of a data structure (e.g., data structure 122, 322 in FIGS. 1B and 3B) that is looped. In some embodiments, the control circuitry may execute the vehicle element control application to determine the grip strength. The control circuitry stores the grip strength in a profile of the user by executing a user profile management application, such as discussed above with respect to FIGS. 1A, 1B, and 5A.

The process 940 continues to operation 944 with the control circuitry determining, based on the stored grip strength, that the user has a health condition. The health condition may not be related to the controlling vehicle elements (e.g., vehicle elements 128, 228 in FIGS. 1A and 2 and vehicle elements 1204, discussed below in relation to FIG. 12) or operating a vehicle (e.g., vehicle 101 in FIG. 1B and vehicle 201 in FIGS. 2 and 6). For example, certain health conditions, such as Parkinson's, muscular dystrophy, rheumatoid arthritis, and cognitive decline or dementia, may be linked to changes in grip strength. The control circuitry monitors the stored grip strength over time, by executing a user health monitoring application, to identify indications that the user is experiencing or about to experience such a health condition. Grip strength may be reduced when the user is dehydrated or fatigued or increased when the user is stressed. The control circuitry provides recommendations when such conditions are determined, such as by recommending the user drink water, refrain from driving and/or get rest, or refrain from driving and/or perform destressing exercises such as breath control or meditation.

In some embodiments, the control circuitry uses a reduction in grip strength over time to determine the user has an elevated risk of injury, such as an increased risk of falling. The control circuitry may inform the user of the elevated risk of injury, and in some instances, may restrict the user from operating the vehicle.

In some embodiments, the control circuitry uses the stored grip strength to evaluate the user's recovery following a hand or arm surgery. For example, a reduced grip strength having reduced pressure values may be determined after such as surgery. The grip strength may return to pre-surgery pressure values over time, and may be compared to an expected time to return to pre-surgery values.

In some embodiments, the control circuitry uses the stored grip strength to monitor chemotherapy patients for peripheral neuropathy, where nerves outside the brain and spinal cord are damaged and may cause weakness in hands of the patients, resulting in a reduced grip strength.

In some embodiments, the steering wheel includes temperature sensors, heart rate sensors, non-invasive glucose monitoring sensors, or sensors to track volatile organic compounds (VOCs) in bodily emissions such as perspiration. The control circuitry monitors data from such sensors over time. The control circuitry executes the user health monitoring application to predict or identify the beginning of a disease or to track the progression of a disease. For example, chemical compounds in bodily emissions may provide an indication for a disease. In some embodiments, the control circuitry may perform an action to control vehicle elements (e.g., vehicle elements 128 in FIG. 1A) if certain sensed biometric parameters exceed a limit, such as locking a vehicle in park if a blood alcohol concentration is too high, or pulling the vehicle over if a user is incapacitated. In some embodiments, the control circuitry may provide recommendation to the user based on the sensors, such as recommending the user ingest carbohydrates when a low glucose level is detected, perform destressing exercises when a high heart rate is detected, or schedule a doctor's appointment when a predetermined VOC profile is detected.

In some embodiments the user is identified based on connection with a device of the user, such as a smartphone. The user device may determine whether the user has a health condition. In some embodiments, the user device may aggregate the stored grip strength with other health data such as heart rate, heart rhythm, blood pressure, skin or body temperature, oxygen saturation, breathing rate, or frequency, duration, intensity, and patterns of the user's movement to determine the user has a health condition.

FIG. 10A shows an illustration of handlebars 1002 having a plurality of zones 1006 for receiving a gesture input, in accordance with embodiments of the disclosure. FIG. 10B shows a side sectional illustration of the handlebars 1002 of FIG. 10A, in accordance with embodiments of the disclosure. Therefore, FIGS. 10A and 10B are herein described together for clarity. The handlebars 1002 may be part of a vehicle, such as a motorcycle, motor-driven cycle, or bicycle.

Referring to FIG. 10A, the handlebars 1002 include a grip 1076 on a left and right side. For simplicity, only the right side of the handlebars 1002 are shown. The left side may mirror the configuration of the right side. The grip 1076 includes pads 1078 having sensors 1004. The sensors 1004 are arranged in zones 1006. The zones 1006 wrap around the grips 1076 such that each zone 1006 is adjacent to two other zones 1006. In the embodiment depicted in FIGS. 10A and 10B, each pad 1078 includes four zones. Each pad 1078 may correspond to a finger of a user (e.g., a rider of the motorcycle) such that when the user grips the grip 1076, a tip of each finger rests on its own pad. This beneficially allows each finger to perform a gesture input using up to four zones 1006 to result in an action to control vehicle elements (e.g., vehicle elements 128 and 228 in FIGS. 1A and 2, respectively). In some embodiments, the pads 1078 are contiguous such that no space exists between upper and lower pads 1078.

FIG. 11 is a schematic illustration of a process 1140 of tracking finger movements on a steering wheel (e.g., steering wheel 102 in FIGS. 1A and 1B, steering wheel 202 in FIGS. 2 and 6, steering wheel 402 in FIGS. 4A and 4B, steering wheels 502A and 502B in FIG. 5B, steering wheel 702 and 802 in FIGS. 7 and 8, and handlebars 1002 in FIGS. 10A and 10B) of a vehicle (e.g., vehicle 101 in FIG. 1B and vehicle 201 in FIGS. 2 and 6) to control elements (e.g., vehicle elements 128 and 228 in FIGS. 1A and 2) of the vehicle, in accordance with embodiments of the disclosure. The process 1140 shown in FIG. 11 may be implemented, in whole or in part, by one or more systems or devices described herein.

The process 1140 begins at operation 1142 with I/O circuitry (e.g., I/O circuitry 192 and 292 in FIGS. 1A and 2 and I/O path 1216, discussed below in relation to FIG. 12) continuously receiving data from the plurality of sensors (e.g., sensors 104, 204, 404, 1004 discussed in relation to FIGS. 1A and 1B, 2, 4, and 10), such as described above with respect to FIGS. 1A and 1B.

The process 1140 continues to operation 1144 with control circuitry (e.g., control circuitry 190 and 290 in FIGS. 1A and 2 and control circuitry 1212, discussed below in relation to FIG. 12) identifying each of the fingers on the steering wheel, by executing a vehicle element control application, based on the received data from the plurality of sensors. For example, the number of fingers of the user may be known and the sensor data may indicate discrete regions of contact with the steering wheel that correspond to each finger. In some embodiments, the control circuitry may perform operation 1142.

The process 1140 continues to operation 1146 with the control circuitry determining a gesture input from at least one of the fingers to the steering wheel based on the received data from the plurality of sensors. The control circuitry executes a vehicle interface application to receive the data and the vehicle control application to determine gesture inputs. For example, each finger of the user may be tracked to determine if a finger moves (e.g., a contact area with the steering wheel moves), lifts off the steering wheel (e.g., a contact area decreases or disappears), or presses down on the steering wheel (e.g., a contact area increases or reappears).

The process 1140 continues to operation 1148 with the control circuitry deciding whether a rate of change of a turn angle of the steering wheel is less than a turn rate threshold. The rate of change of the steering wheel turn angle indicates the rate the steering wheel is turning, such as in a clockwise or counterclockwise direction. If the steering wheel is turning at a rate that exceeds the turn rate threshold, then the user may be actively turning the vehicle and no action should be taken based on the gesture inputs since the user may be focused on operating the vehicle on not controlling the vehicle elements. The rate of change of the turn angle may be determined using sensors, such as resolvers, encoders, position sensors, angular position sensors, angular rate sensors, to name a few examples. If the decision is no, then the process 1140 continues to operation 1142 to continue to receive data from the sensors.

If the decision is yes, then the process 1140 continues to operation 1150 with the control circuitry, based on the gesture input, performing an action to control at least one element (e.g., vehicle elements 128 and 228 in FIGS. 1A and 2, respectively) of the vehicle. For example, the control circuitry, by executing the vehicle element control application, may look up the gesture input in a database or data structure to determine if there is a corresponding action to control a vehicle element associated with the gesture input. In some embodiments, the control circuitry interfaces with the vehicle elements through the I/O circuitry. In such embodiments, the control circuitry may output data or commands to the I/O circuitry, and the I/O circuitry sends instructions to perform the action to control the vehicle elements. If no gesture input is found in the database, then the process may continue to operation 1142.

In some embodiments, operation 1148 may be used with processes 140, 240, and 740 previously described in relation to FIGS. 1A and 1B, 2, and 7, such as between operations 150 and 152, such as between operations 158 and 162, such as between operations 246 and 248, such as prior to operation 744.

FIG. 12 depicts example devices and related hardware for receiving input on a steering wheel (e.g., user input interface 1202) of a vehicle (e.g., vehicle 101 in FIG. 1B and vehicle 201 in FIGS. 2 and 6) and performing an action to control at least one element (e.g., vehicle elements 1204) of the vehicle based on the input, in accordance with some embodiments of the disclosure. FIG. 12 shows a generalized embodiment of illustrative vehicle computing device 1200. Vehicle computing device 1200 may receive data via I/O path 1216, and may process input data and output data using I/O circuitry (e.g., I/O circuitry 192, 292 in FIGS. 1A and 2). I/O path 1216 may provide content (e.g., data structures, user profile information, Internet content, content available over a local area network (LAN) or wide area network (WAN), and/or other content) and data (e.g., data structures, data from sensors array 1208) to control circuitry 1212, which includes processing circuitry 1210 and storage 1214. Control circuitry 1212 may be used to send and receive commands, requests, and other suitable data using I/O path 1216.

Control circuitry 1212 may be based on any suitable processing circuitry such as processing circuitry 1210. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry 1210 may be distributed across multiple separate processors or processing units. In some embodiments, control circuitry 1212 executes instructions for multiple applications stored in non-transitory memory (i.e., storage 1214). Specifically, control circuitry 1212 may be instructed by a vehicle element control application, vehicle interface application, input analysis application, profile management application, or user health monitoring application, to name a few examples, to perform the functions discussed in this disclosure. For example, the vehicle element control application may provide instructions to control circuitry 1212 to determine time series of pressures for zones of a steering wheel, and/or to provide data from the sensor array 1208 via the vehicle user input interface 1202 (e.g., steering wheel 102 in FIGS. 1A and 1B, steering wheel 202 in FIGS. 2 and 6, steering wheel 402 in FIGS. 4A and 4B, steering wheels 502A and 502B in FIG. 5B, steering wheel 702 and 802 in FIGS. 7 and 8, and handlebars 1002 in FIGS. 10A and 10B). The sensor array 1208 may be arranged into a plurality of zones (e.g., zones 106, 206, 406, 506A and 506B, 806, 1006 in FIGS. 1, 2, 4, 5, 8, and 10) on the vehicle user input interface 1202. In some implementations, any action performed by control circuitry 1212 may be based on instructions received from the vehicle element control application.

In client/server-based embodiments, control circuitry 1212 may include communications circuitry suitable for communicating with an application server or other networks or servers. The instructions for carrying out the above-mentioned functionality may be stored on the application server. Communications circuitry may include SATCOM, a 5G or 6G modem, a cable modem, an integrated-services digital network (ISDN) modem, a digital subscriber line (DSL) modem, a telephone modem, Ethernet card, a wireless modem, and/or one or more CAN busses or Ethernet transceivers for communications with other equipment, or any other suitable communications circuitry. Such communications may involve the Internet or any other suitable communications networks or paths (which are described in more detail in connection with FIG. 13). In some embodiments, the sensor array 1208 is provided in the vehicle computing device 1200. The sensor array 1208 may be used for capturing pressure data, conductivity data, and/or any other data described herein, generating various data, and making various determinations and identifications as discussed in this disclosure. The sensor array 1208 may include various sensors, such as one or more pressure sensors or transducers, vibration sensors, accelerometers, gyroscopes, eddy current sensors, capacitive displacement sensors, or skin conductivity sensors, for example. The sensor array 1208 may also include sensor circuitry which enables the sensors to operate and receive and transmit data to and from the control circuitry 1212 and various other components of the vehicle computing device 1200. In addition, communications circuitry may include circuitry that enables peer-to-peer communication of user equipment devices, or communication of user equipment devices in locations remote from each other (described in more detail below).

Memory may be an electronic storage device provided as storage 1214 that is part of control circuitry 1212. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1214 may be used to store various types of content described herein as well as content data and application data that are described above. Nonvolatile memory may also be used (e.g., to launch a boot-up routine and other instructions). Cloud-based storage may be used to supplement storage 1214 or instead of storage 1214.

Sensor array 1208 and/or control circuitry 1212 may include digital-to-analog converter circuitry and analog-to-digital converter circuitry for converting between digital and analog signals.

In one embodiment, vehicle elements 1204 may be provided as integrated with other elements of vehicle computing device 1200 or may be stand-alone units.

In some embodiments, the sensor array 1208 is provided in the vehicle computing device 1200. The sensor array 1208 may be used to monitor, identify, and/or determine interaction of a user with the vehicle user input interface 1202. For example, the vehicle interface application may receive sensor data from the sensor array (e.g., pressure sensors) that are used to determine a time series of pressures for each zone of the vehicle user input interface 1202 or determine a gesture input from at least one of the fingers to the vehicle user input interface 1202.

The multiple applications may be implemented using any suitable architecture. For example, each application may be a stand-alone application wholly implemented on vehicle computing device 1200. In such an approach, instructions of the applications are stored locally (e.g., in storage 1214), and data for use by the applications is downloaded on a periodic basis (e.g., from an out-of-band feed, from an Internet resource, or using another suitable approach). Control circuitry 1212 may retrieve instructions of the application from storage 1214 and process the instructions to carry out any of the functions discussed herein. Based on the processed instructions, control circuitry 1212 may determine what action to perform when input is received from user input interface 1202. For example, a request to perform an action to control at least one vehicle element may be indicated by the processed instructions when the user input interface 1202 indicates that a user's hands (e.g., hands 108, 808 in FIGS. 1A and 1B and 8) have contacted the user input interface 1202. In some examples, a vehicle may include multiple electronic control units (ECUs) used in conjunction to achieve one or more functions. For example, the sensor array 1208 may be fitted with its own processing circuitry (similar to processing circuitry 1210) and storage (similar to storage 1214) and may communicate via an I/O path (similar to I/O path 1216) to another processing circuitry and/or storage. Similarly, vehicle elements 1204 and user input interface 1202 may be connected to another processing circuitry and/or storage. This architecture enables various components to be separated and may segregate functions to provide failure separation and redundancy.

In some embodiments, the multiple applications are client/server-based applications. Data for use by a thick or thin client implemented on vehicle computing device 1200 is retrieved on-demand by issuing requests to a server remote to the vehicle computing device 1200. In one example of a client/server-based application, control circuitry 1212 runs a web browser that interprets web pages provided by a remote or edge server. For example, the remote server may store the instructions for the application in a storage device. The remote server may process the stored instructions using circuitry (e.g., control circuitry 1212) and carry out one or more of the functions discussed herein. The client device may receive data from the remote server and may also carry out one or more of the functions discussed herein locally on vehicle computing device 1200. This way, the processing of the instructions is performed at least partially remotely by the server while other functions are executed locally on vehicle computing device 1200. Vehicle computing device 1200 may receive inputs from the user or occupant of the vehicle via user input interface 1202 and transmit those inputs to the remote server for processing. For example, vehicle computing device 1200 may transmit, via one or more antenna, communication to the remote server, indicating that a user interface element was selected via user input interface 1202. The remote server may process instructions in accordance with that input and generate a display of content identifiers associated with the selected user interface element. The generated display is then transmitted to vehicle computing device 1200 for presentation to the user or occupant of the vehicle.

In some embodiments, the at least one of the multiple applications is downloaded and interpreted or otherwise run by an interpreter or virtual machine (run by control circuitry 1212). The at least one application may operate in connection with or as a part of an electronic control unit (ECU) of a vehicle. The ECU may be one of many ECUs of the vehicle, wherein each ECU operates to control a particular set of functions of the vehicle, such as engine controls, power train controls, transmission controls, brake controls, etc. The at least one application may operate in connection with one or more ECUs of the vehicle in order to carry out the functions described herein.

Vehicle computing device 1200 of FIG. 12 can be implemented in system 1300 of FIG. 13 as vehicle interface equipment 1314, vehicle computer equipment 1316, wireless user communications device 1322, or any other type of user equipment. For simplicity, these devices may be referred to herein collectively as interface equipment or interface equipment devices and may be substantially similar to the vehicle computing device 1200 described above. In some embodiments, the vehicle computer equipment 1316, which includes the control circuitry 1212, the I/O path 1216, and storage 1214 discussed in relation to FIG. 12, communicates over the communication network 1310 with a server to send and receive data from the vehicle element control application data source 1304, untrained or trained machine learning models (e.g., DNN 310 or trained DNN 320 in FIG. 3) that the vehicle computer equipment 1316 implements, and any other necessary data. Interface equipment devices, on which one or more functions of multiple applications described herein may be implemented, may function as stand-alone devices or may be part of a network of devices. Various network configurations of devices may be implemented and are discussed in more detail below.

FIG. 13 depicts example systems, servers, and related hardware for enabling a vehicle element control application to carry out the functions described herein, in accordance with some embodiments of the disclosure. An interface equipment device utilizing at least some of the system features described above in connection with FIG. 13 may not be classified solely as vehicle interface equipment 1314, vehicle computer equipment 1316 (e.g., backend processing equipment), or a wireless user communications device 1322. For example, vehicle interface equipment 1314 may, like some vehicle computer equipment 1316, be Internet-enabled, allowing for access to Internet content, while wireless user communications device 1322 may, like some vehicle interface equipment 1314, include a tuner allowing for access to media programming. The vehicle input interface 1314 may include the user input interface discussed in relation to FIG. 12. The vehicle element control application may have the same layout on various types of user equipment or may be tailored to the display capabilities of the interface equipment. For example, on wireless user communications device 1322, the vehicle element control application may be provided as a website accessed by a web browser. In another example, the vehicle element control application may be scaled down for wireless user communications devices 1322.

The interface equipment devices may be coupled to communications network 1310. Communications network 1310 may be one or more networks including the Internet, a mobile phone network, mobile voice or data network (e.g., a 4G, 5G, 6G, or LTE network), or other types of communications network or combinations of communications networks.

System 1300 includes content source 1302 and vehicle element control application data source 1304 coupled to communications network 1310. Communications with the content source 1302 and the vehicle element control application data source 1304 may be exchanged over one or more communications paths but are shown as a single path in FIG. 13 to avoid overcomplicating the drawing. Although communications between sources 1302 and 1304 with user equipment devices 1314, 1316, and 1322 are shown through communications network 1310, in some embodiments, sources 1302 and 1304 may communicate directly with user equipment devices 1314, 1316, and 1322.

Content source 1302 may include one or more types of content distribution equipment including a data storage facility, programming sources, intermediate distribution facilities and/or servers, Internet providers, on-demand media servers, and other content providers. Vehicle element control application data source 1304 may provide data from a user input interface (e.g., user input interface 1202 in FIG. 12), which may include data from sensors (e.g., sensors 104, 204, 404, 1004, 1208 discussed in relation to FIGS. 1A and 1B, 2, 4, 10, and 12), or a list of actions to control vehicle elements (e.g., vehicle elements 128, 228, 1204 in FIGS. 1A, 2, and 12). Vehicle element control application data may be provided to the interface equipment devices using any suitable approach. In some embodiments, vehicle element control application data from the vehicle element control application data source 1304 may be provided to the interface equipment using a client/server approach. For example, an interface equipment device may pull data from a server, or a server may present the data to an interface equipment device.

The embodiments discussed above are intended to be illustrative and not limiting. One skilled in the art would appreciate that individual aspects of the apparatus and methods discussed herein may be omitted, modified, combined, and/or rearranged without departing from the scope of the disclosure. Only the claims that follow are meant to set bounds as to what the present disclosure includes.

1. A system comprising:
a plurality of sensors disposed on a steering wheel of a vehicle to sense contact of a user's hands with the steering wheel of the vehicle,
wherein the plurality of sensors are arranged into a plurality of zones that wrap around the steering wheel such that each zone of the plurality of zones is adjacent to two other zones of the plurality of zones;
input/output circuitry configured to:
continuously receive data from the plurality of sensors; and
control circuitry configured to:
determine a respective time series of pressures for each respective zone of the plurality of zones based on the received data from a subset of sensors of the plurality of sensors that are in each respective zone;
store each respective time series of pressures in a data structure that is looped such that the time series of pressures for each zone is treated as adjacent to the time series of pressures of two other zones;
based on analyzing the data structure that is looped, identifying an action to control at least one element of the vehicle; and
performing the action to control the at least one element of the vehicle.

2. The system of claim 1, the control circuitry further configured to:
analyze the data structure that is looped by comparing the time series of pressures of the data structure that is looped to a time series of pressures of a reference data structure that is associated with the action to control at least one element of the vehicle.

3. The system of claim 2, wherein:
the reference data structure comprises a table where each row contains a time series of pressures for a zone of a plurality of training zones; and
comparing the time series of pressures of the data structure that is looped to the time series of pressures of the reference data structure comprises:
determining a pattern in the time series of pressures of the table of the data structure that is looped matches a pattern in the time series of pressures of the table of the reference data structure, wherein the pattern in the time series of pressures of the data structure that is looped corresponds to different row numbers than the pattern in the time series of pressures of the reference data structure.

4. The system of claim 2, wherein the control circuitry is configured to analyze the data structure that is looped by inputting the time series of pressures of the data structure that is looped into a trained machine learning model, wherein the machine learning model was trained by:
accessing a time series of pressures of a training data structure and a corresponding action to control at least one element of the vehicle, wherein the reference data structure is the training data structure;
inputting the time series of pressures of the training data structure to output a determined action to control at least one element of the vehicle; and
adjusting the machine learning model based on comparing the determined action to control the at least one element of the vehicle with the corresponding action to control the at least one element of the vehicle.

5. The system of claim 2, further comprising:
the input/output circuitry further configured to:
receive a request to train the system to perform the action to control the at least one element of the vehicle; and
the control circuitry further configured to:
generate the reference data structure by:
storing, in the reference data structure, a respective time series of pressures for each respective zone of the plurality of zones; and
associating the respective time series of pressures for each respective zone stored in the reference data structure with the action to control the at least one element of the vehicle.

6. The system of claim 2, wherein:
the reference data structure is generated using a different steering wheel of a different vehicle; and
a number of zones in a plurality of training zones that wrap around the different steering wheel of the different vehicle is different than the number of zones in the plurality of zones that wrap around the steering wheel of the vehicle.

7. The system of claim 2, further comprising:
a plurality of liquid tactile buttons on the steering wheel; and
the control circuitry further configured to:
based on the comparing, inflate a liquid tactile button located in a zone of the plurality of zones that corresponds to the time series of pressures of the data structure that is looped, wherein performance of the action to control the at least one element of the vehicle is in response to a user interaction with the liquid tactile button.

8. The system of claim 1, wherein the data structure that is looped comprises a table where the last row is considered adjacent to the first row and each row contains the time series of pressures for a zone of the plurality of zones.

9. The system of claim 1, wherein the data structure that is looped comprises a circular stack, ring buffer, or circular buffer.

10. The system of claim 1, further comprising:
the control circuitry further configured to:
determine a rate of change of a turn angle of the steering wheel is less than a turn rate threshold, wherein performing the action is in response to determining the rate of change of the turn angle is less than the turn rate threshold.

11. The system of claim 1, further comprising:
the control circuitry further configured to:
determine a grip strength of at least one of the user's hands based on the time series of pressures of the data structure that is looped;
store the grip strength in a profile of the user; and
determine, based on the stored grip strength, that the user has a health condition.

12. The system of claim 1, wherein the time series of pressures for the plurality of zones comprises pressures in two noncontiguous subsets of zones that are higher than the remaining zones of the plurality of zones.

13. The system of claim 1, wherein the steering wheel comprises handlebars having grips and the plurality of sensors are arranged into a plurality of zones that wrap around the grips such that each zone of the plurality of zones is adjacent to two other zones of the plurality of zones.

14. A system comprising:
a plurality of sensors disposed on a steering wheel of a vehicle to sense contact of a user's fingers with the steering wheel;
input/output circuitry configured to:
continuously receive data from the plurality of sensors; and
control circuitry configured to:
identify each of the fingers on the steering wheel based on the received data from the plurality of sensors;
determine a gesture input from at least one of the fingers to the steering wheel based on the received data from the plurality of sensors; and
based on the gesture input, perform an action to control at least one element of the vehicle.

15. A method comprising:
sensing contact of a user's hands with a steering wheel of a vehicle,
wherein the steering wheel comprises a plurality of zones that wrap around the steering wheel such that each zone of the plurality of zones is adjacent to two other zones of the plurality of zones;
determining a respective time series of pressures for each respective zone of the plurality of zones;
storing each respective time series of pressures in a data structure that is looped such that the time series of pressures for each zone is treated as adjacent to the time series of pressures of two other zones;
based on analyzing the data structure that is looped, identifying an action to control at least one element of the vehicle; and
performing the action to control the at least one element of the vehicle.

16. The method of claim 15, further comprising:
analyzing the data structure that is looped by comparing the time series of pressures of the data structure that is looped to a time series of pressures of a reference data structure that is associated with the action to control at least one element of the vehicle.

17. The method of claim 16, wherein:
the reference data structure comprises a table where each row contains a time series of pressures for a zone of a plurality of training zones; and
comparing the time series of pressures of the data structure that is looped to the time series of pressures of the reference data structure comprises:
determining a pattern in the time series of pressures of the table of the data structure that is looped matches a pattern in the time series of pressures of the table of the reference data structure, wherein the pattern in the time series of pressures of the data structure that is looped corresponds to different row numbers than the pattern in the time series of pressures of the reference data structure.

18. The method of claim 16, further comprising analyzing the data structure that is looped by inputting the time series of pressures of the data structure that is looped into a trained machine learning model, wherein the machine learning model was trained by:
accessing a time series of pressures of a training data structure and a corresponding action to control at least one element of the vehicle, wherein the reference data structure is the training data structure;
inputting the time series of pressures of the training data structure to output a determined action to control at least one element of the vehicle; and
adjusting the machine learning model based on comparing the determined action to control the at least one element of the vehicle with the corresponding action to control the at least one element of the vehicle.

19. The method of claim 16, further comprising:
generating the reference data structure by:
storing, in the reference data structure, a respective time series of pressures for each respective zone of the plurality of zones; and
associating the respective time series of pressures for each respective zone stored in the reference data structure with the action to control the at least one element of the vehicle.

20. The method of claim 16, wherein:
the reference data structure is generated using a different steering wheel of a different vehicle; and
a number of zones in a plurality of training zones that wrap around the different steering wheel of the different vehicle is different than the number of zones in the plurality of zones that wrap around the steering wheel of the vehicle.

21-69. (canceled)
